(19) United States
(12) Patent Application Publication
(10) Pub. No.: US 2025/0219168 A1
(43) Pub. Date: Jul. 3, 2025

(54) Battery Energy Storage System With Flexible Interconnection Control and Applications Thereof

(71) Applicant: QPO Energy, LLC, Tualatin, OR (US)

(72) Inventors: Virgil Lee BEASTON, Vestal, NY (US); Jason LU, Shoreline, WA (US); Shijie SUN, Qingdao City (CN); Shawn Brian RICE, Portland, OR (US); Kyle Michael WITCOSKY, Beaverton, OR (US)

(21) Appl. No.: 19/003,251

(22) Filed: Dec. 27, 2024

Related U.S. Application Data
(60) Provisional application No. 63/556,482, filed on Feb. 22, 2024.
(60) Provisional application No. 63/616,211, filed on Dec. 29, 2023.

(51) Int. Cl. H01M 10/42; H01M 10/48

(52) U.S. Cl. CPC H01M 10/425; H01M 10/48; H01M 2010/4271; H01M 2010/4278; H01M 2220/10

(57) ABSTRACT

Provided is a battery energy storage system with remote monitoring, maintenance, and control. The battery energy storage system includes a residential battery energy storage unit having a battery module, a battery management system coupled to the battery module, a bi-directional power converter, and a communication controller configured to communicate with the battery management system and the bi-directional power converter. The communication controller sends error codes via the internet to a server to enable an operating issue with the residential battery energy storage unit to be corrected remotely. The communication controller translates error codes received from the battery management system to new error codes that are sent to the server. The communication controller receives data messages from the battery management system and sends information from the received data message to the bi-directional power converter using a new message format. The communication controller can receive control information that controls the charging and discharging of the battery module.

### CROSS-REFERENCE TO RELATED APPLICATIONS

The present application claims benefit of U.S. Provisional Patent Application No. 63/616,211, filed on Dec. 29, 2023, and U.S. Provisional Patent Application No. 63/556,482, filed on Feb. 22, 2024, each of which is incorporated herein by reference in its entirety.

### BACKGROUND

Battery energy storage systems are important for integrating renewable energy and helping transition to a clean energy economy. These systems help improve the reliability and stability of the electrical power grid and reduce energy costs for consumers. Unfortunately, the total cost of ownership of these systems has been a significant barrier to their widespread deployment, especially at the commercial and industrial level and even more so at the residential level. A lot of the costs of ownership associated with these systems are related to their installation, remote monitoring, and maintenance after they are sold. What is needed are improved battery energy storage systems with a lower total cost of ownership.

### SUMMARY

The embodiments featured herein help solve or mitigate the above-mentioned issues as well as additional shortcomings relating to battery energy storage systems.

Some embodiments of this disclosure can include a battery energy storage system. The battery energy storage system can include a residential battery energy storage unit having at least one battery module, a battery management system coupled to the at least one battery module, a bi-directional power converter, and a communication controller configured to communicate with the battery management system and the bi-directional power converter. In these embodiments, the communication controller can send one or more error codes via the internet to a server to enable an operating issue with the residential battery energy storage unit to be corrected remotely.

In some embodiments, the communication controller can receive control information from a Public Utility District (PUD) or utility that controls the charging and discharging of the battery energy storage system units as well as the amount of power that may be feed back to the grid by the batteries and or solar panels of the units.

Further features and advantages of the disclosure, as well as the structure and operation of various embodiments, are described in detail below with reference to the accompanying drawings. It is noted that the disclosure is not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS

Together with the following detailed descriptions, the accompanying drawings illustrate a number of exemplary embodiments in addition to describing and demonstrating various aspects and/or principles set forth in the present disclosure. The accompanying drawings and the brief descriptions are provided to enable one of ordinary skill in the art to practice the various aspects and/or principles set forth in the present disclosure.

FIG. 1 illustrates an example battery energy storage system with remote monitoring, maintenance, and control according to an embodiment of the present disclosure.

FIGS. 2A-2B illustrate an example battery energy storage system according to an embodiment of the present disclosure.

FIG. 3 illustrates an example battery energy storage system according to an embodiment of the present disclosure.

FIGS. 4-10 illustrate an example battery module according to an embodiment of the present disclosure.

FIG. 11 illustrates an example residential battery energy storage system according to an embodiment of the present disclosure.

FIGS. 12A-12C illustrate an example residential battery energy storage system according to an embodiment of the present disclosure.

FIG. 13 illustrates an example modular all-in-one residential battery energy storage system according to an embodiment of the present disclosure.

FIG. 14 illustrates an example residential battery energy storage system with remote monitoring according to an embodiment of the present disclosure.

FIG. 15 illustrates an example battery energy storage system with remote monitoring, maintenance, and control according to an embodiment of the present disclosure.

FIG. 16 illustrates the commissioning of a battery energy storage system with remote monitoring, maintenance, and control according to an embodiment of the present disclosure.

FIGS. 17A-17C illustrate an example relational database used in embodiments of the present disclosure.

FIG. 18 illustrates an example graphical user interface of a remote battery energy storage monitoring system according to an embodiment of the present disclosure.

FIG. 19 illustrates an example graphical user interface of a remote battery energy storage monitoring system according to an embodiment of the present disclosure.

FIG. 20 illustrates an example customer monitoring system according to an embodiment of the present disclosure.

FIG. 21 illustrates an example graphical user interface of a customer battery energy storage monitoring system according to an embodiment of the present disclosure.

FIG. 22 illustrates an example graphical user interface of a customer battery energy storage monitoring system according to an embodiment of the present disclosure.

FIGS. 23A-23D illustrate an example remote battery energy storage monitoring system according to an embodiment of the present disclosure.

FIG. 24 illustrates example graphical user interfaces of a remote battery energy storage monitoring system according to an embodiment of the present disclosure.

FIG. 25 illustrates an exemplary communications controller for a battery energy storage system with remote monitoring, maintenance, and control according to an embodiment of the present disclosure.

FIG. 26A illustrates an example communications controller for a battery energy storage system with remote monitoring, maintenance, and control according to an embodiment of the present disclosure.

FIG. 26B illustrates an example communications controller for a battery energy storage system with remote monitoring, maintenance, and control according to an embodiment of the present disclosure.

FIGS. 27, 28A, and 28B illustrate an example battery management system for a battery energy storage system with remote monitoring, maintenance, and control according to an embodiment of the present disclosure.

FIG. 29-30 illustrate an example battery management system for a battery energy storage system with remote monitoring, maintenance, and control according to an embodiment of the present disclosure.

FIG. 31 illustrates a monitoring center controlling the operation of multiple example battery energy storage system with remote monitoring, maintenance, and control according to an embodiment of the present disclosure.

FIG. 32 illustrates a system for integrating battery energy storage systems into an electrical distribution system.

FIGS. 33A-33F illustrate example graphical user interfaces of a remote battery energy storage monitoring and maintenance system according to an embodiment of the present disclosure.

FIGS. 34-36 illustrate Public Utility District (PUD) or utility control of a fleet of battery energy storage system units according to an embodiment of the present disclosure.

### DETAILED DESCRIPTION

The following disclosure provides many different embodiments, or examples, for implementing features of the provided subject matter. Specific examples of components and arrangements are as described herein to simplify the present disclosure. These are, of course, merely examples and are not intended to be limiting. Aspects of the present disclosure are best understood from the following detailed description when read with the accompanying figures. The present disclosure may repeat reference numerals and/or letters in the various examples. This repetition does not dictate a relationship between the various embodiments and/or configurations discussed. It is noted that, in accordance with the standard practice in the industry, features are not drawn to scale. In fact, the dimensions of the features may be arbitrarily increased or reduced for clarity of discussion. The following disclosure may include the terms “about” or “substantially” to indicate the value of a given quantity can vary based on a particular technology. Based on the technology, the term “about” or “substantially” can indicate a value of a given quantity that varies within, for example, 1-15% of the value (e.g., ±1%, ±2%, ±5%, ±10%, or ±15% of the value).

Embodiments of the disclosure can be implemented in hardware, firmware, software application, or any combination thereof. Embodiments of the disclosure can also be implemented as instructions stored on a machine-readable medium, which can be read and executed by one or more processors. A machine-readable medium can include any mechanism for storing or transmitting information in a form readable by a machine (e.g., a computing circuitry). For example, a machine-readable medium can include non-transitory machine-readable mediums such as read only memory (ROM); random access memory (RAM); magnetic disk storage media; optical storage media; flash memory devices; and others. As another example, the machine-readable medium can include transitory machine-readable medium such as electrical, optical, acoustical, or other forms of propagated signals (e.g., carrier waves, infrared signals, digital signals, etc.). Further, firmware, software application, routines, instructions can be described herein as performing certain actions. However, it should be appreciated that such descriptions are merely for convenience and that such actions in fact result from computing devices, processors, controllers, or other devices executing the firmware, software application, routines, instructions, etc.

Embodiments will be described below in more detail with reference to the accompanying drawings. The following detailed descriptions are provided to assist the reader in gaining a comprehensive understanding of the methods, apparatuses, and/or systems described herein as well as modifications thereof. Accordingly, various modifications and equivalents of the methods, apparatuses, and/or systems described herein will be apparent to those of ordinary skill in the art. Descriptions of well-known functions and constructions may be omitted for increased clarity and conciseness.

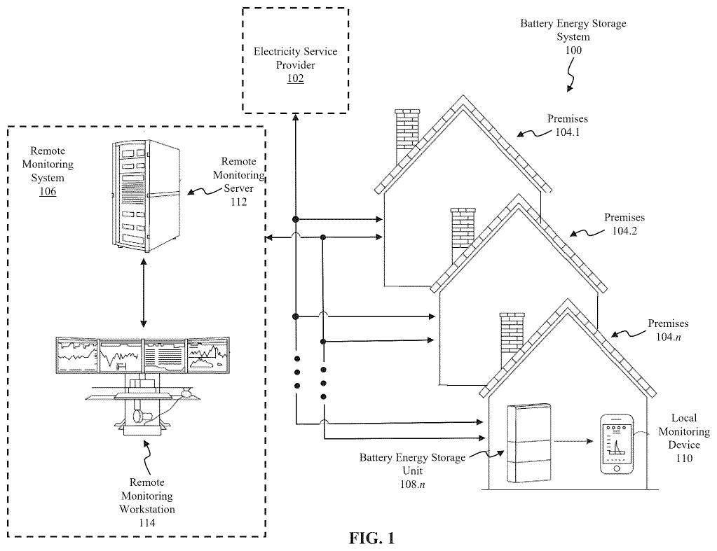

FIG. 1 illustrates a simplified block diagram of an exemplary battery energy storage system (BESS) according to some exemplary embodiments of the present disclosure. In the exemplary embodiment illustrated in FIG. 1, a battery energy storage system (BESS) 100 can monitor, maintain, and/or control one or more BESS units within one or more premises. In some embodiments, the one or more BESS units can provide their statuses to the BESS 100. In these embodiments, the one or more BESS units can provide their statuses to the BESS 100 at discrete intervals in time, for example, multiple times every day, once every few minutes, once every hour, once every few hours, once every day, once every couple of days, once every week, once every couple of weeks, once every month, and/or once every couple of months to provide some examples, to assist in detecting any errors, faults, failures, performance degradation, and/or maintenance needs. Alternatively, or in addition to, these one or more BESS units can provide their statuses to the BESS 100 in response to an event, for example, detecting any errors, faults, failures, performance degradation, and/or maintenance needs. In these embodiments, these statuses can indicate that their corresponding BESS units are operating normally without detecting any errors, faults, failures, performance degradation, and/or maintenance needs. Alternatively, or in addition to, these statuses can indicate that their corresponding BESS units are not operating normally. In some embodiments, these statuses can indicate that their corresponding BESS units have errors, faults, failures, performance degradation, and/or maintenance needs. In these embodiments, the BESS 100 can remotely access these corresponding BESS units to diagnose and/or address issues preventing their normal operation. This can include identifying and resolving errors, faults, failures, performance degradation, or maintenance needs. As illustrated in FIG. 1, the BESS 100 can include an electricity service provider 102, such as a Public Utility District (PUD), or other suitable entity, premises 104.1 through 104.n, and a remote monitoring system 106.

In the exemplary embodiment illustrated in FIG. 1, the electricity service provider 102 represents a company or an organization that provides electricity to customers, for example, either households, businesses, and/or industries, among others, and/or receive electricity, for example, excess electricity, from these customers. In some embodiments, the electricity service provider 102 can be responsible for ensuring that the customers receive continuous and reliable supplies of the electricity, for example, through the use of a power grid. In these embodiments, the electricity service provider 102 can maintain the electricity infrastructure, including power plants that generate the electricity, transmission lines, and/or distribution systems, among others, to ensure that the electricity is delivered safely and reliably. In some embodiments, the electricity service provider 102 can step down the electricity from higher transmission voltages to lower working voltages for delivery to the households, the businesses, and/or the industries, among others. In some embodiments, the electricity service provider 102 can manage consumer accounts, issuing bills based on consumption of the electricity, responding to service issues, and offering customer support.

The premises 104.1 through 104.n, such as the households, the businesses, and/or the industries, among others represent one or more customers of the electricity service provider 102. As illustrated in FIG. 1, the premises 104.1 through 104.n can include battery energy storage system (BESS) units 108.1 through 108.n. In some embodiments, the BESS units 108.1 through 108.n can store electrical energy in one or more battery cells and/or battery modules for later use. In some embodiments, the BESS units 108.1 through 108.n can store electricity remotely generated by the electricity service provider 102 in the one or more battery cells and/or battery modules. Alternatively, or in addition to, the BESS units 108.1 through 108.n can store electricity locally generated by wind, hydroelectric, wind, and/or solar panels among others. Generally, the BESS units 108.1 through 108.n can include one or more battery cells to store the electricity, one or more power conversion systems (PCS), for example, inverters, to convert the direct current (DC) electricity stored in the BESS units 108.1 through 108.n into alternating current (AC) electricity, one or more Battery Management Systems (BMSs) to monitor and manage the health of the BESS units 108.1 through 108.n ensuring they operate safely and efficiently, and/or one or more communications controllers to monitor, maintain, and/or control BESS units 108.1 through 108.n, among others.

In some embodiments, the BESS units 108.1 through 108.n can be connected to the power grid to allow the BESS units 108.1 through 108.n to store, for example, charge the electricity from the electricity service provider 102 and/or to supply, for example, discharge, the electricity stored within the BESS units 108.1 through 108.n to the electricity service provider 102, for example, when needed. In these embodiments, the electricity service provider 102 can control the operation of the BESS units 108.1 through 108.n to either charge or discharge the electricity. For example, the electricity service provider 102 can include an Energy Management System (EMS) that oversees the operation of the power grid. In this example, the EMS can interface with the BESS units 108.1 through 108.n to determine when to charge the electricity, when to discharge the electricity, and/or how much electricity to deliver based on the needs, energy prices, and/or grid conditions, among others. In some embodiments, the EMS can monitor the state of the BESS units 108.1 through 108.n, for example, charge level, temperature, and/or health, among others, control when the BESS units 108.1 through 108.n are charged or discharged, and/or respond to real-time grid conditions and external factors, such as supply and demand fluctuations to provide some examples, within the power grid.

In the exemplary embodiment illustrated in FIG. 1, the remote monitoring system 106 can remotely monitor, maintain, and/or control the BESS units 108.1 through 108.n. As illustrated in FIG. 1, the remote monitoring system 106 can include a remote monitoring server 112 and a remote monitoring station 114. In some embodiments, the remote monitoring server 112 can access the statuses of the BESS units 108.1 through 108.n. In these embodiments, the remote monitoring server 112 can receive status messages from the BESS units 108.1 through 108.n respectively, over a network, for example, the Internet, that indicate the statuses of the BESS units 108.1 through 108.n. For example, the BESS units 108.1 through 108.n can transmit the status messages in accordance with various communication protocols, such as Hypertext Transfer Protocol (HTTP), Transmission Control Protocol/Internet Protocol (TCP/IP), Real-time Transport Protocol/Real-time Streaming Protocol (RTP/RTSP), Internetwork Packet Exchange (IPX), and/or User Datagram Protocol (UDP), among others. In some embodiments, the remote monitoring server 112 can receive the status messages from the BESS units 108.1 through 108.n, respectively, at discrete intervals in time, for example, multiple times every day, once every few minutes, once every hour, once every few hours, once every day, once every couple of days, once every week, once every couple of weeks, once every month, and/or once every couple of months to provide some examples. In some embodiments, the remote monitoring server 112 can identify those BESS units from among the BESS units 108.1 through 108.n for which the remote monitoring server 112 did not receive their status messages. In these embodiments, the remote monitoring server 112 can determine that these BESS units have errors, faults, failures and can proceed in a substantially similar manner as described below.

In some embodiments, the status messages can indicate those BESS units from among the BESS units 108.1 through 108.n that are operating normally without detecting any errors, faults, failures, performance degradation, and/or maintenance needs. For example, those BESS units can provide the remote monitoring server 112 with a positive status message, such as an “OK message,” to indicate that it is operating normally without detecting any errors, faults, failures, performance degradation, and/or maintenance needs. Alternatively, or in addition to, the status messages can indicate those BESS units from among the BESS units 108.1 through 108.n are not operating normally. In these embodiments, the status messages can indicate those BESS units from among the BESS units 108.1 through 108.n have errors, faults, failures, performance degradation, and/or maintenance needs. In some embodiments, those BESS units can provide the remote monitoring server 112 with a negative status message, such as a “not OK message,” to indicate that they have the errors, faults, failures, performance degradation, and/or maintenance needs. In some embodiments, the status messages, for example, the positive status message and/or the negative status message can include one or more characteristics, parameters, and/or attributes of the BESS units 108.1 through 108.n to diagnose and/or address issues preventing their normal operation. This can include identifying and resolving errors, faults, failures, performance degradation, or maintenance needs of the BESS units 108.1 through 108.n. Alternatively, the remote monitoring server 112 can remotely access the BESS units 108.1 through 108.n, for example, in response to receiving the negative status messages, to diagnose and/or address issues preventing their normal operation In these embodiments, the remote monitoring server 112 can remotely access the BESS units 108.1 through 108.n to monitor the one or more characteristics, parameters, and/or attributess 108.1 through 108.n and can thereafter utilize these characteristics, parameters, and/or attributes to diagnose and/or remedy these errors, faults, failures, performance degradation, and/or maintenance needs. This can include identifying and resolving errors, faults, failures, performance degradation, or maintenance needs of the BESS units 108.1 through 108.n.

The remote monitoring station 114 can generate one or more BESS reports for monitoring and analyzing the performance, health, and efficiency of the BESS 100. In some embodiments, the remote monitoring station 114 can calculate, estimate, and/or derive the one or more BESS reports from the statuses received from the BESS units 108.1 through 108.n. In these embodiments, the statuses received from the BESS units 108.1 through 108.n can be aggregated and/or collated with respect to one another to monitor and analyze the performance, health, and efficiency of the BESS 100. In some embodiments, the one or more BESS reports can be related to remote monitoring software functions, remote monitoring of the BESS units 108.1 through 108.n, remote reset of the BESS units 108.1 through 108.n, installation and/or creation of the BESS units 108.1 through 108.n, management of the BESS units 108.1 through 108.n, customer accounts associated with the BESS units 108.1 through 108.n, electrician company accounts associated with the electricity service provider 102, electrician accounts, distributor and reseller accounts, work orders, uploading images to database via electrician portal, uploading serial numbers to the BESS units 108.1 through 108.n in database via electrician portal, displaying all active devices and work orders, and/or manufacturing portal for connecting sales orders to devices, among others.

In the exemplary embodiment illustrated in FIG. 1, the remote monitoring station 114 can execute one or more graphical user interfaces (GUIs) to display the one or more BESS reports. In some embodiments, the one or more GUIs operate by allowing customer service representatives, service personnel, technicians, or the like to interact with software through visual elements such as buttons, menus, and icons. In these embodiments, the customer service representatives, the service personnel, the technicians, or the like can select various BESS reports from different screens for display by the one or more GUIs. For example, the customer service representatives, the service personnel, the technicians, or the like can start by clicking on a menu or button that lists the one or more BESS reports. Once a BESS report from among the one or more BESS reports is selected, the one or more GUIs retrieve the corresponding characteristics, parameters, and/or attributes from the remote monitoring system 106 and display the BESS report on a new screen or in a pop-up window. The BESS report may be formatted as tables, charts, or graphs, and the customer service representatives, the service personnel, the technicians, or the like interact with these displays by scrolling, zooming, or filtering the BESS report as needed. In some embodiments, the one or more GUIs operate can allow the customer service representatives, the service personnel, the technicians, or the like to switch between multiple BESS reports by offering navigation buttons or tabs that dynamically update the screen to show the selected BESS report, ensuring a seamless and efficient user experience.

Various exemplary embodiments for the electricity service provider 102, the premises 104.1 through 104.n, and/or the remote monitoring system 106 are to be described in further detail below. And these various exemplary embodiments can provide additional details and refinements to the electricity service provider 102, the premises 104.1 through 104.n, and/or the remote monitoring system 106 as described in FIG. 1. The various exemplary embodiments for the electricity service provider 102, the premises 104.1 through 104.n, and/or the remote monitoring system 106 to be described in further detail below may also introduce other features and aspects that may or may not have been described FIG. 1 as will be apparent to those skilled in the relevant art(s) without departing from the spirit and scope of the present disclosure. Those skilled in the relevant art(s) can readily modify and/or adapt the electricity service provider 102, the premises 104.1 through 104.n, and/or the remote monitoring system 106 as described in FIG. 1 to include these other features and aspects without departing from the spirit and scope of the present disclosure. And in some embodiments, one or more of these operations of the remote monitoring server 112 and/or the remote monitoring station 114 can be locally performed by one or more local monitoring devices 110, for example, a smart phone, within, or approximate to, one or more of the premises from among the premises 104.1 through 104.n as to be described in further detail below.

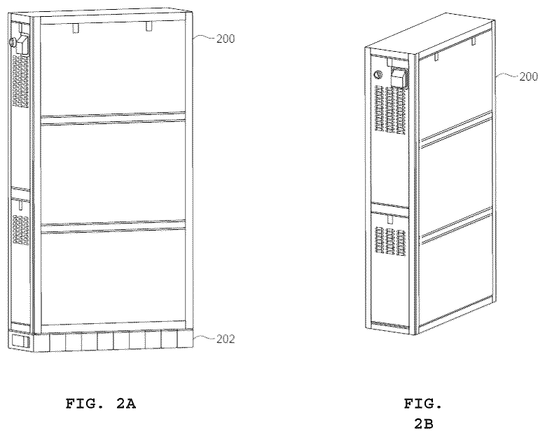

FIGS. 2A-B illustrate an example battery energy storage system (BESS) unit 200 according to an embodiment of the present disclosure. FIG. 2A shows a front view of BESS unit 200 sitting on a support base 202. FIG. 2B shows a side view of BESS unit 200.

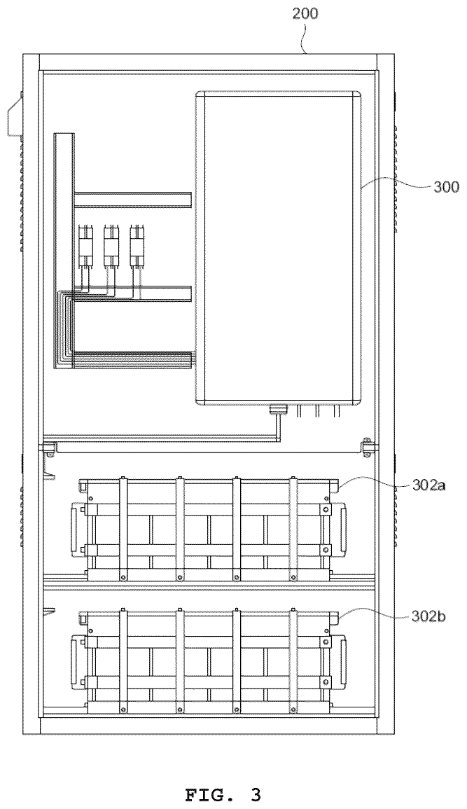

FIG. 3 illustrates an embodiment of BESS unit 200 with the front panels of BESS unit 200 removed. As shown, BESS unit 200 includes a bi-directional power converter 300 and two lithium-ion battery modules 302a and 302b.

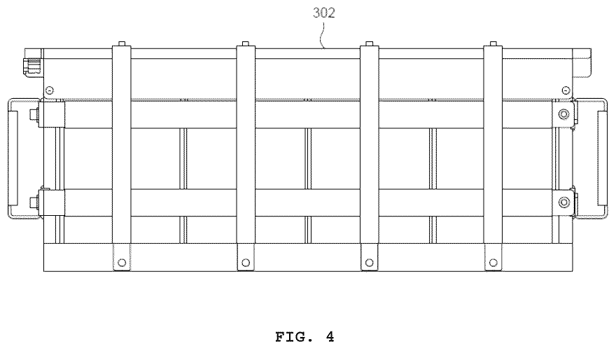

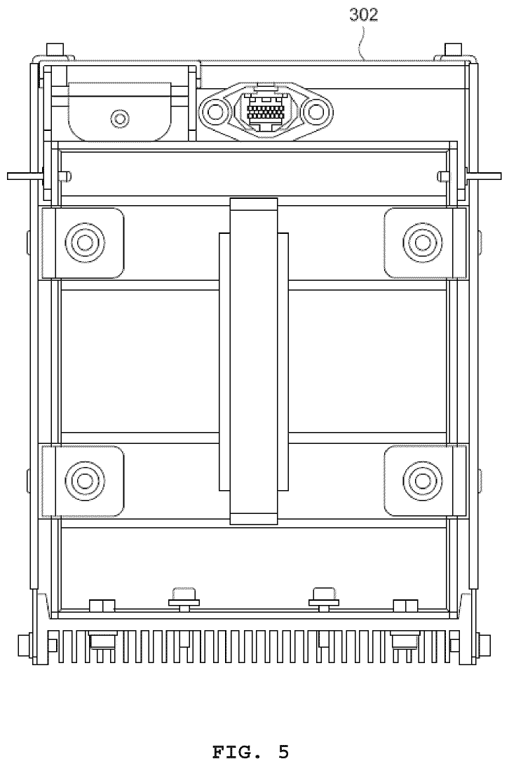

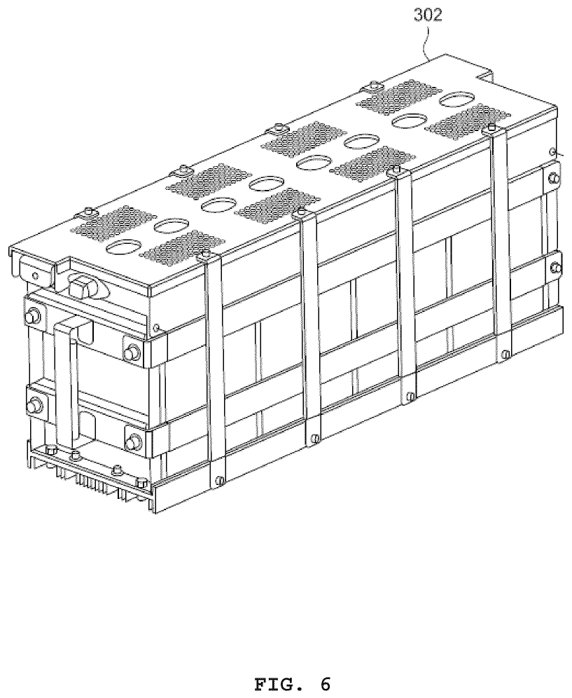

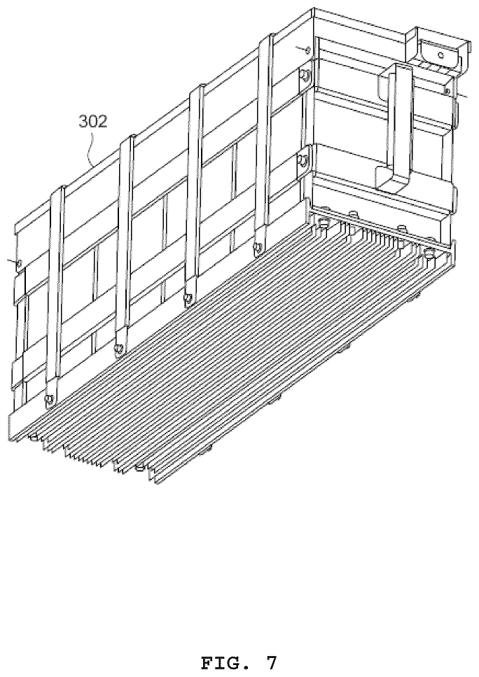

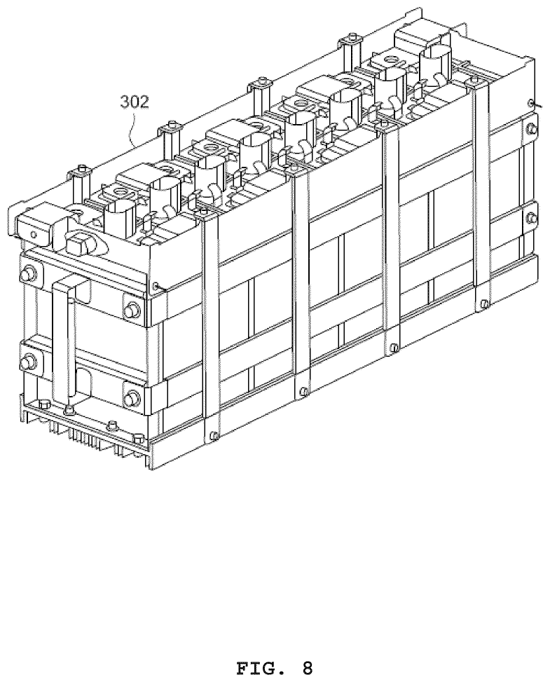

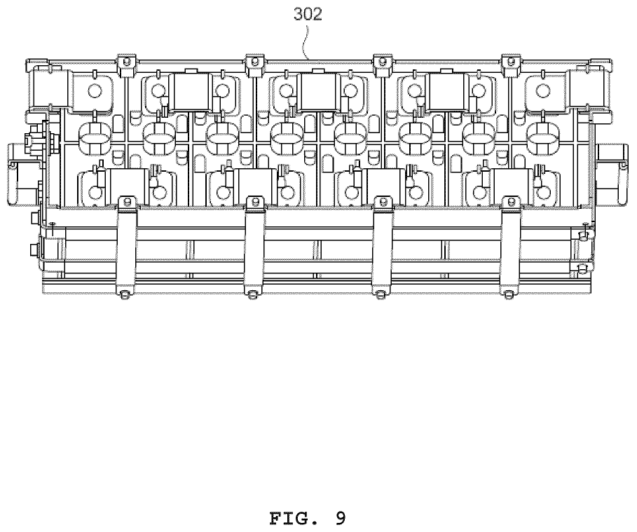

FIGS. 4-10 further illustrate battery module 302 according to an embodiment of the present disclosure. FIG. 4 is a side view of battery module 302. FIG. 5 is an end view of battery module 302. FIG. 6 is a top oblique view of battery module 302. FIG. 7 is a bottom oblique view of battery module 302. FIG. 8 is a top oblique view of battery module 302 with the top cover removed. FIG. 9 is a second top view of battery module 302 with the top cover removed.

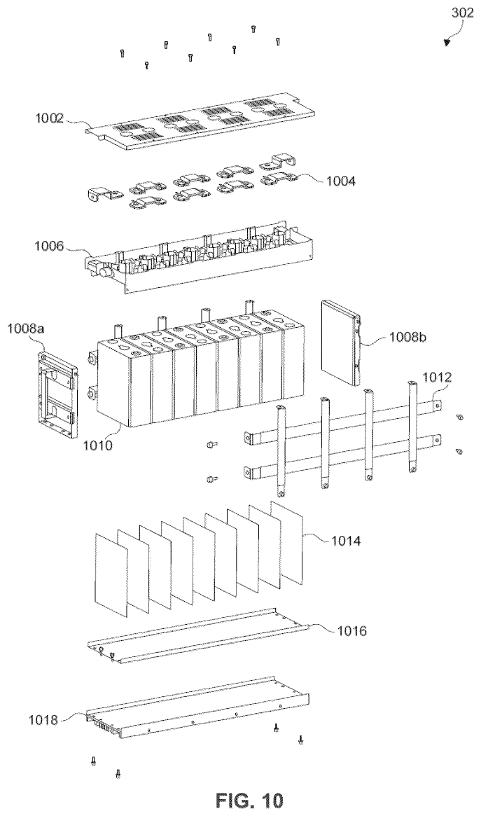

FIG. 10 is an exploded view of battery module 302, which shows the various components that make up battery module 302. As shown in FIG. 10, in an embodiment battery module 302 includes a top cover 1002, busbars 1004, a top tray 1006, two end plates 1008a and 1008b, eight battery cells 1010, retaining bars 1012, battery cell separators 1014, a bottom plate insulator 1016, and a bottom plate 1018. Also shown are several different types of fasteners.

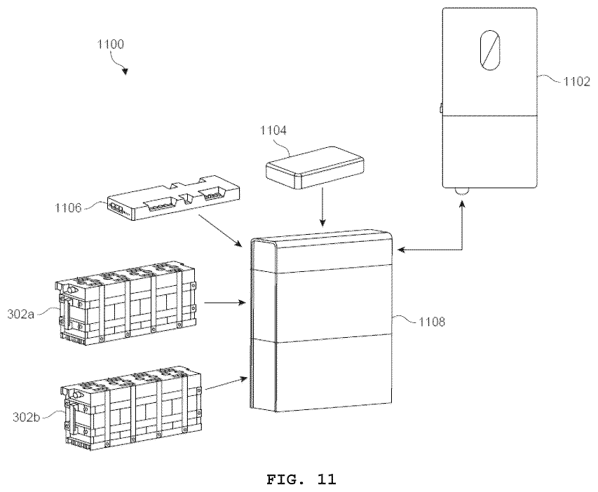

FIG. 11 illustrates an example residential battery energy storage system (BESS) unit 1100 according to an embodiment of the present disclosure. As shown in FIG. 11, BESS unit 1100 includes a bi-directional power converter 1102, a communication controller 1104, a battery management system (BMS) 1106, two battery modules 302a and 302b, and an enclosure 1108. In embodiments, enclosure 1108 is a modular enclosure comprising two battery module sections and one BMS-Communications section.

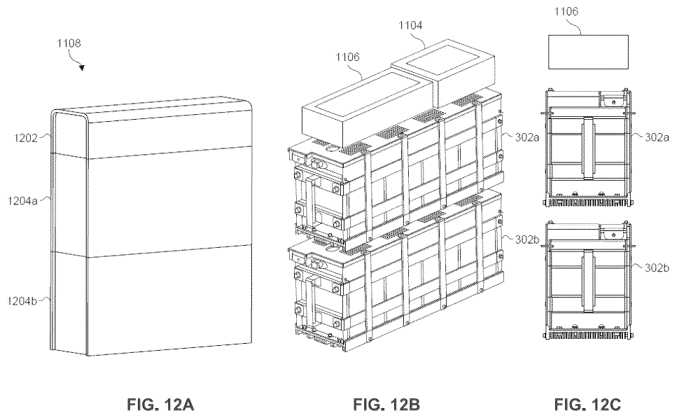

FIGS. 12A-C further illustrate BESS unit 1100 according to an embodiment of the present disclosure. FIG. 12A shows enclosure 1108. In FIG. 12A, enclosure 1108 has a BMS-communications section 1202 and two battery modules sections 1204a and 1204b. BMS-communications section 1202 houses BMS 1106 and communications controller 1104. Battery module section 1204a houses battery module 302a. Battery module section 1204b houses battery module 302b.

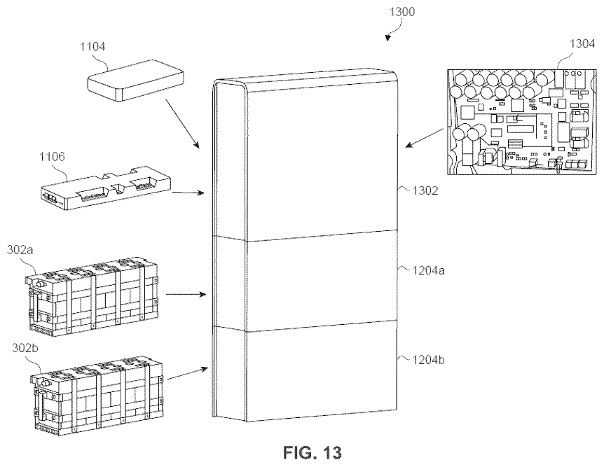

FIG. 13 illustrates an example modular all-in-one residential battery energy storage system (BESS) unit 1300 according to an embodiment of the present disclosure. As shown in FIG. 13, BESS unit 1300 includes a bi-directional power converter 1304, a communication controller 1104, a battery management system (BMS) 1106, two battery modules 302a and 302b, and an enclosure having a power converter section 1302 and two battery module sections 1204a and 1204b. Power converter section 1302 houses bi-directional power converter 1304, communication controller 1104, and BMS 1106. Battery module section 1204a houses battery module 302a. Battery module section 1204b houses battery module 302b.

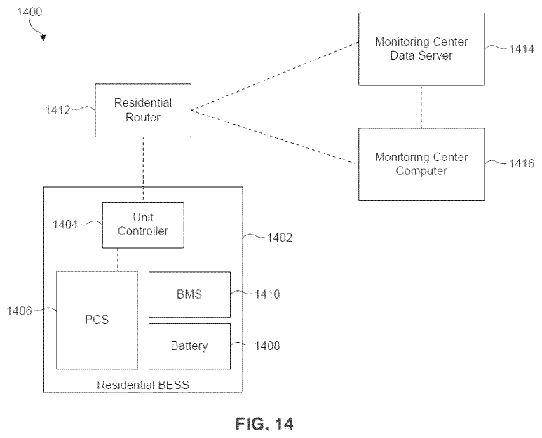

FIG. 14 illustrates an example residential battery energy storage system (BESS) 1400 with remote monitoring according to an embodiment of the present disclosure. As shown in FIG. 14, BESS 1400 includes a residential BESS unit 1402 that has a unit controller 1404, a power conversion system (PCS) 1406, a battery 1408, and a battery management system (BMS) 1410. BESS 1400 also includes a residential router 1412, a monitoring center data server 1414, and a monitoring center computer 1416.

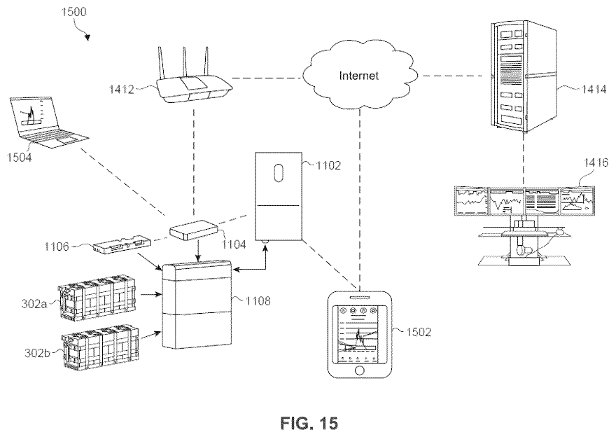

FIG. 15 illustrates an example battery energy storage system (BESS) 1500 with remote monitoring, maintenance, and control according to an embodiment of the present disclosure. In an embodiment, BESS 1500 includes BESS unit 1100, which has a bi-directional power converter 1102, a communication controller 1104, a battery management system (BMS) 1106, two battery modules 302a and 302b, and an enclosure 1108. Also included in BESS 1500 is residential router 1412, monitoring center data server 1414, and monitoring center computer 1416. A smartphone 1502 can be used by customers to set the operating mode and parameters of BESS unit 1100 and to monitor BESS unit 1100. A laptop computer 1504 can be used by technicians, for example, when initially setting up and commissioning BESS unit 1100.

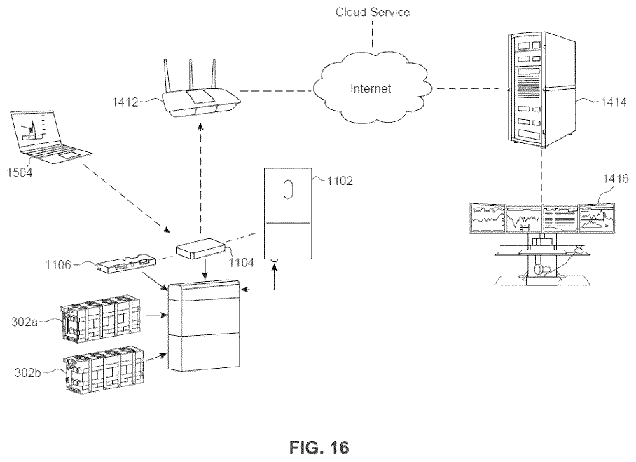

In FIG. 15, the dotted lines illustrate the various communication links between the devices of BESS 1500. These communications are described below, for example, with references to FIGS. 16-24.

FIG. 16 further illustrates operation of BESS 1500 during the commissioning of a battery energy storage system with remote monitoring, maintenance, and control according to an embodiment of the present disclosure. In an embodiment, after BESS unit 1100 has been installed and powered on by an installer, the installer is able to monitor the communications between bi-directional power converter 1102 and communication controller 1104, and the communications between battery management system (BMS) 1106 and communication controller 1104. The installer monitors these communications using laptop computer 1504 or a similar smart device such as a tablet or a smart phone. Monitoring these communications lets the installer know that BESS unit 1100 is operating as expected and without any errors.

After the installer verifies BESS unit 1100 is operating properly, the installer uses laptop computer 1504 or a similar smart device to connect BESS unit 1100 to the internet via residential router 1412. This enables BESS unit 1100 to start communicating with monitoring center data server 1414, and an operator using monitoring center computer 1416 can see the data communicated by BESS unit 1100 and verify BESS unit 1100 is operating as expected and without any errors. The installer and/or the operator can then update, for example, the residential customers data in a customer relationship database as well as other information about BESS unit 1100 as described in more detail below. Once BESS unit 1100 is communicating with monitoring center data server 1414, has been verified by an operator to be operating as expected and without any errors, and the data relating to the installation and BESS unit 1100 has been collected and updated in the database described in more detail below, the installation is considered completed.

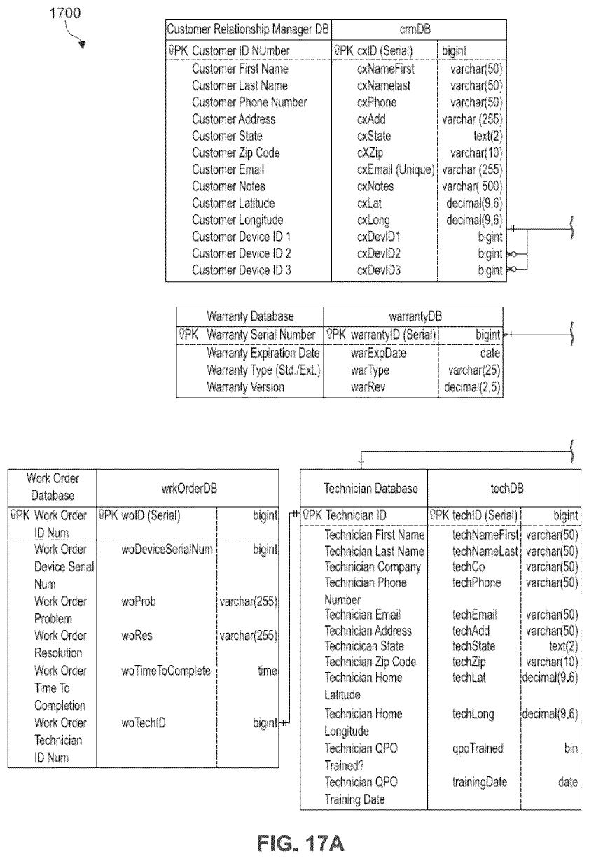

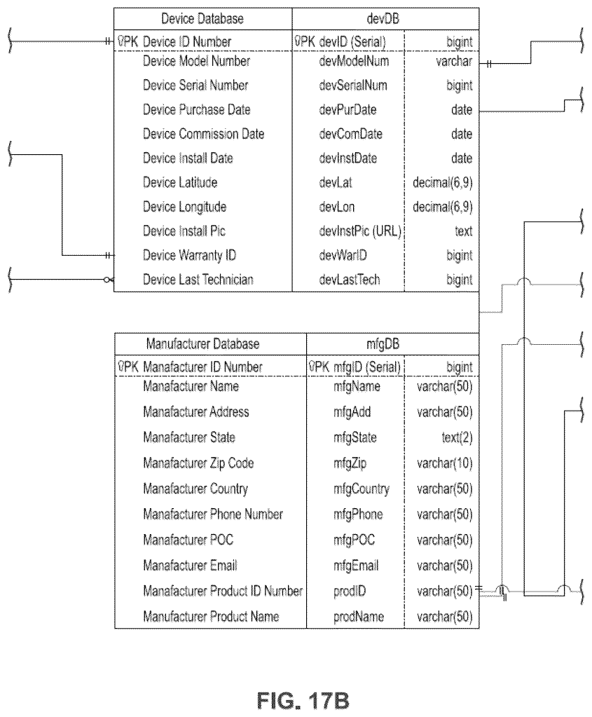

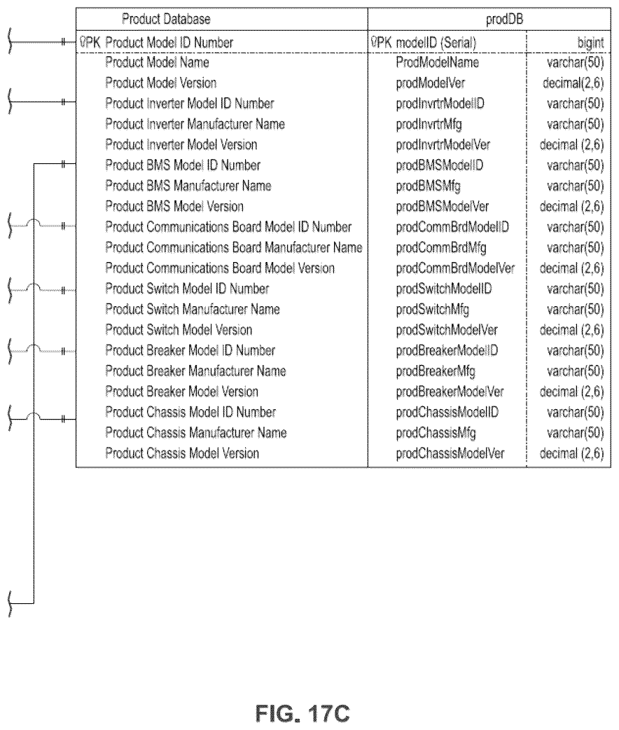

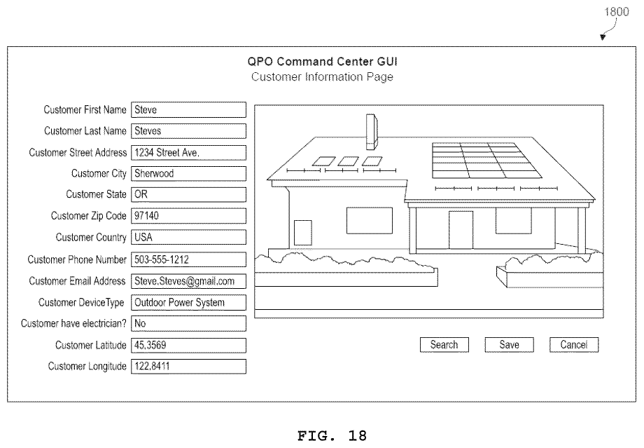

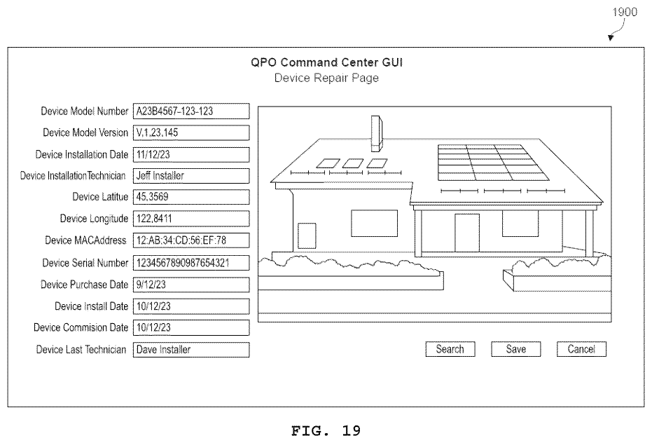

FIGS. 17A-C illustrate an example relational database 1700 used in embodiments of the present disclosure. Database 1700 includes data related to Customer Relationship Manager, the specific installed BESS unit, the model of the installed BESS unit, the manufacturer of the installed BESS unit, the warranty information for the installed BESS unit, the installer of the BESS unit, error codes for the installed BESS unit, and workorders for the installed BESS unit. Information stored in database 1700 related to Customer Relationship Management, for example, includes Customer ID, Customer First Name, Customer Last Name, Customer Phone Number, Customer Address, Customer State, Customer Zip Code, Customer Email Address, Notes about the Customer, Customer Latitude, and Customer Longitude. Information stored in database 1700 related to the specific installed BESS unit includes, for example, Device ID Number, Device Model Number, Device Serial Number, Device & Customer ID Combined, Date of Device's Purchase, Date of Device's Commissioning, Date of Device Installation, Latitude of Device Installation Location, Longitude of Device Installation Location, Pictures of the Installed Device, Device's Warranty ID, and Last Tech to Service the Device. Information stored in database 1700 related to the model of the installed BESS unit includes, for example, Model ID, Product Model Name, Product Model Version, Inverter Model Number, Inverter Manufacturer, Inverter Model Version, BMS Model Number, BMS Manufacturer, BMS Model Version, Communication Controller Model Number, Communication Controller Manufacturer, Communication Controller Model Version, Switch Model Number, Switch Manufacturer, Switch Model Version, Breaker Model Number, Breaker Manufacturer, Breaker Model Version, Enclosure Model Number, Enclosure Manufacturer, and Enclosure Model Version. Information stored in database 1700 related to the manufacturer of the installed BESS unit includes, for example, Manufacturer ID Number, Manufacturer Name, Manufacturer Address, Manufacturer State, Manufacturer Zip Code, Manufacturer Country, Manufacturer Phone Number, Manufacturer Point of Contact, Manufacturer Email Address, Product Name (Manufacturer's), and Product Model Number (Manufacturer's). Information stored in database 1700 related to the warranty information for the installed BESS unit includes, for example, Warranty ID Number, Warranty Expiration Date, Type of Warranty, and Warranty Revision. Information stored in database 1700 related to the installer (Technician) of the BESS unit includes, for example, Technician's ID Number, Technician's First Name, Technician's Last Name, Technician's Company, Technician's Phone Number, Technician's Email Address, Technician's Street Address, Technician's State, Technician's Zip Code, and Technician's Training Date. Information stored in database 1700 related to error codes for the installed BESS unit includes, for example, Error Code ID, Error Code Name, Error Code Description, Error Severity, and Recommended Actions To Correct Error. Information stored in database 1700 related to workorders for the installed BESS unit includes, for example, Work Order ID Number, Work Order Serial Number, Work Order Serial Number of the Device, Problem which Generated the Work Order, Resolution to the Work Order problem, Date Work Order Completed, and Technician's ID Who Completed Work Order. Other data and information may also be stored in database 1700.

FIG. 18 illustrates an example graphical user interface (GUI) 1800 of a remote battery energy storage monitoring system according to an embodiment of the present disclosure. GUI 1800 displays customer relationship information stored in database 1700.

FIG. 19 illustrates an example graphical user interface (GUI) 1900 of a remote battery energy storage monitoring system according to an embodiment of the present disclosure. GUI 1900 displays data and information about an installed BESS unit.

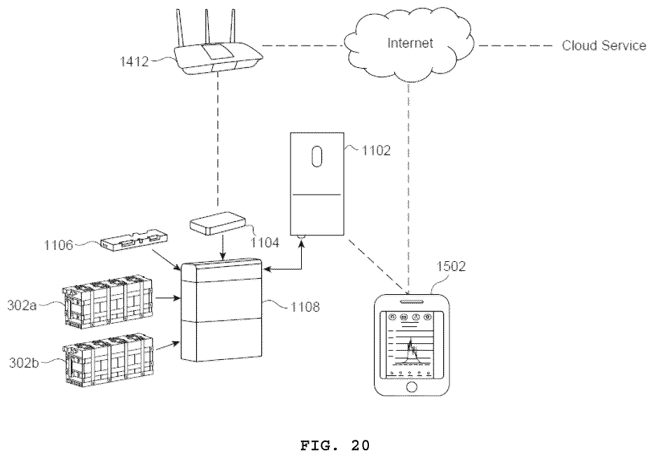

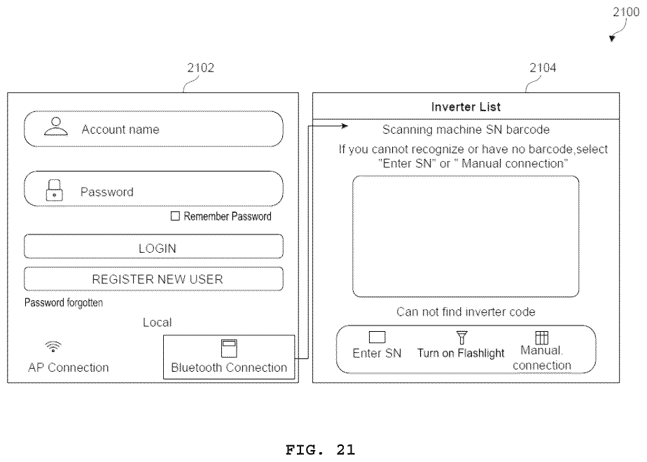

FIG. 20 illustrates operations of BESS 1500 to monitor BESS unit 1100 according to an embodiment of the present disclosure. As described herein, communication controller 1104 gathers data from bi-directional power converter 1102 and/or BMS 1106 and communicates this information via the internet to a cloud server. This information includes, for example, information about the operation of BESS unit 1100 such as how much energy is being stored and discharged, how much energy is available in BESS unit 1100, and how much money has been saved by the customer by its use of BESS unit 1100, as well as other information described herein. The customer can monitor and view this information using a smart phone 1502. In embodiments, the data displayed on smart phone 1502 can be gathered either from data stored in by the cloud service or directly from BESS unit 1100.

FIG. 21 illustrates example software 2100 running on smart phone 1502 or on laptop computer 1504 that enables a customer or an installer to connect BESS unit 1100 to the internet. Software 2100 includes two example graphical user interfaces (GUIs) 2102 and 2104. GUI 2102 is used for security control. GUI 2104 is used to connect BESS unit 1100 to the internet, for example, via residential router 1412.

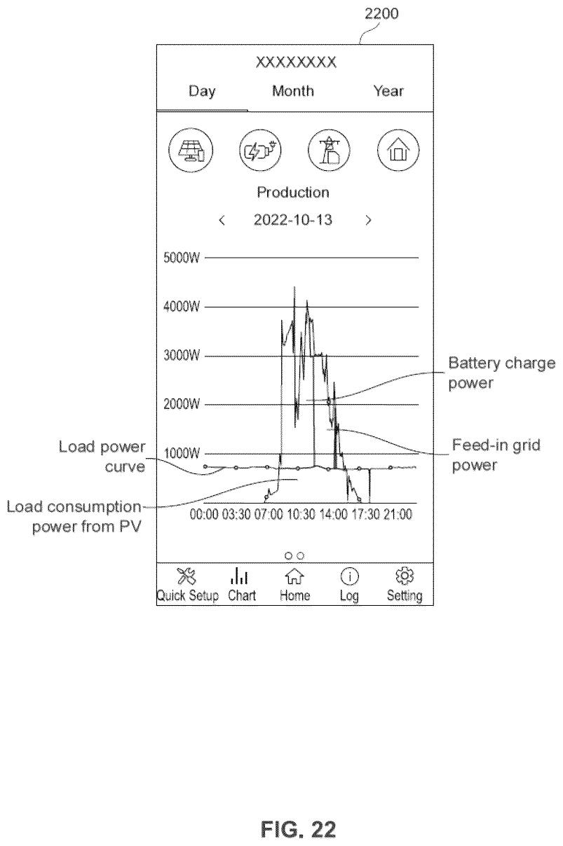

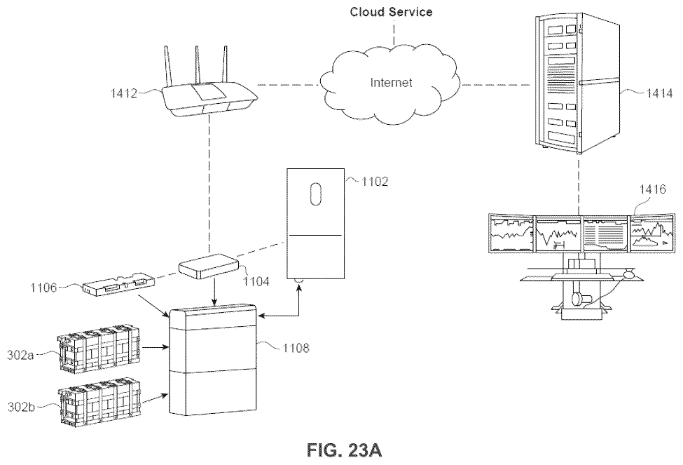

FIG. 22 illustrates an example graphical user interface 2200 of a customer battery energy storage monitoring system according to an embodiment of the present disclosure. GUI 2200 can be displayed on smart phone 1502 and shows data related to the operation, for example, of BESS unit 1100.

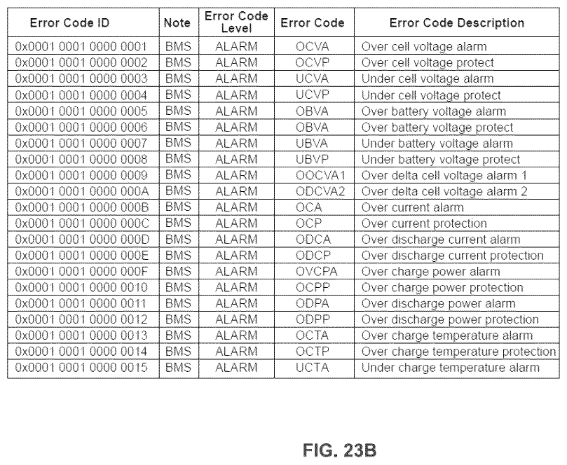

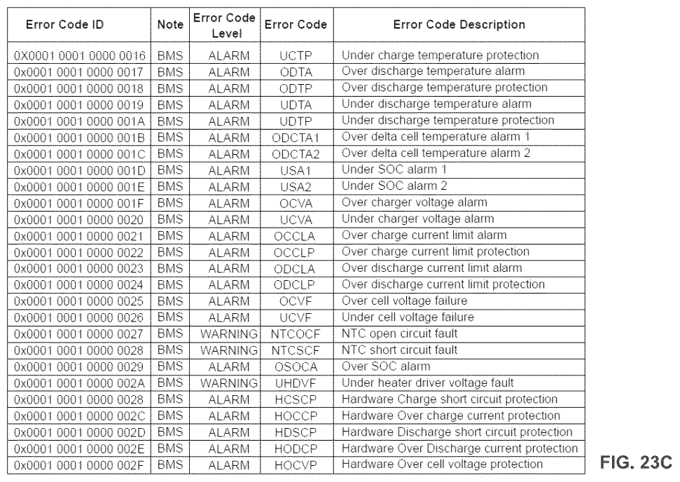

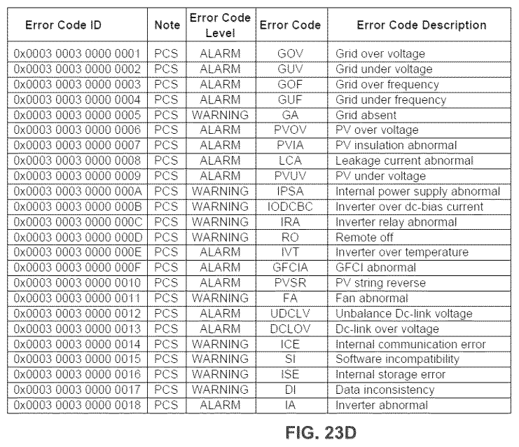

FIGS. 23A-D illustrates operations of BESS 1500 for remote monitoring, maintenance, and control of installed BESS units according to an embodiment of the present disclosure. As described herein, communication controller 1104 gathers data from bi-directional power converter 1102 and/or BMS 1106 and communicates this information via the internet to a cloud server and to monitoring center data server 1414. An operator using monitoring center computer 1416 can see the data communicated by the communication controller of a BESS unit 1100 and verify the BESS unit 1100 is operating as expected and without any errors. Each day installed BESS units send back an <<I′m okay code>>if they are operating as expected without any errors. If a particular BESS unit has an error, it can report its error using an error code. Example error codes are shown in FIGS. 23B-D. This error code can then be used by an operator to correct the error remotely over the internet or to generate a work order, which can then be carried out by a local technician to correct the error and get the BESS unit working as expected and without any errors.

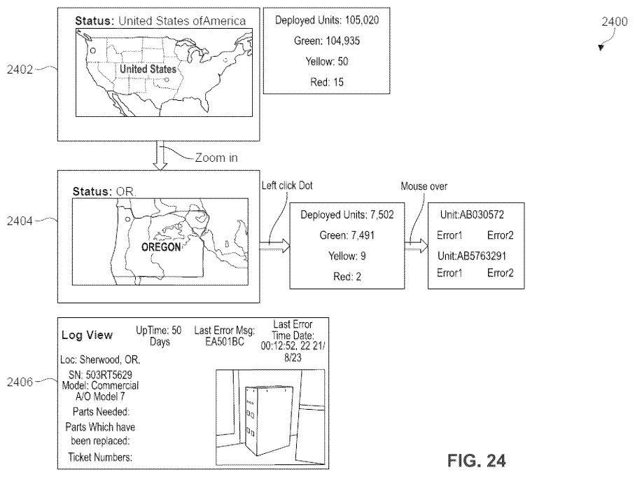

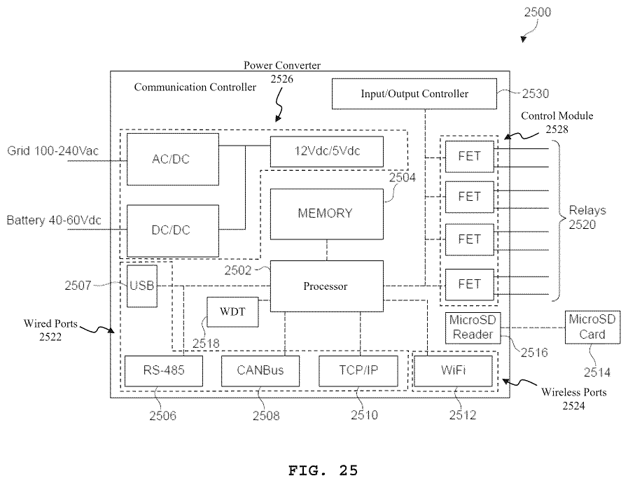

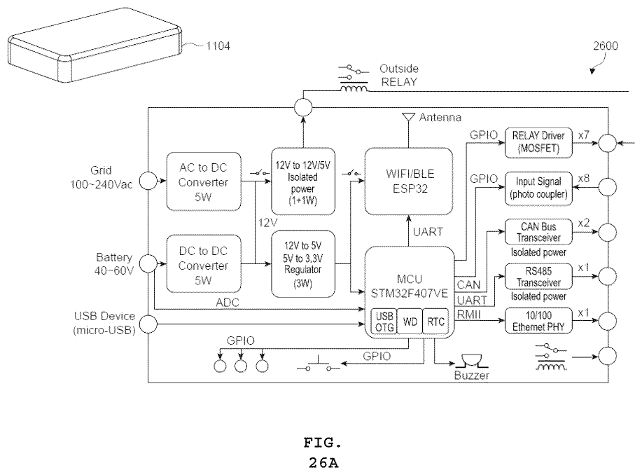

FIG. 24 illustrates example operations 2400 that include three graphical user interfaces (GUIs) for the remote monitoring, maintenance and control of deployed BESS units according to an embodiment of the present disclosure. The GUIs 2402, 2404, and 2406 may be displayed using monitoring center computer 1416. These GUIs enable an operator to determine the status of all installed and monitored BESS units.

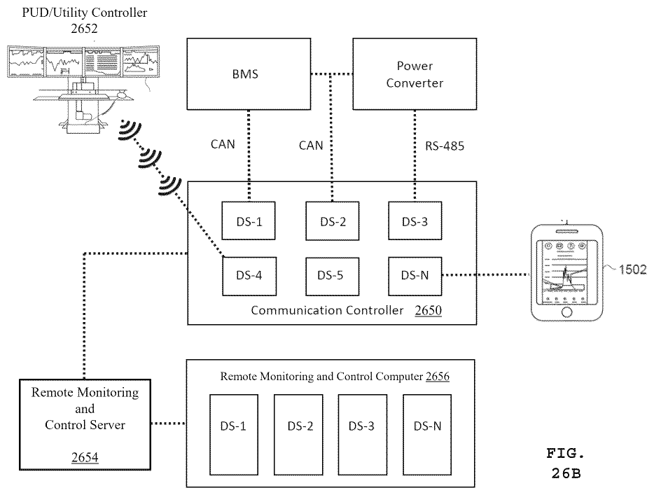

FIG. 25 illustrates an exemplary communications controller for a battery energy storage system with remote monitoring, maintenance, and control according to an embodiment of the present disclosure. In the exemplary embodiment illustrated in FIG. 25, a communications controller 2500 represents an interface between a battery energy storage system (BESS) unit, such as one of the BESS units 108.1 through 108.n to provide an example, and an electricity service provider, such as the electricity service provider 102, and/or a remote monitoring system, such as the remote monitoring system 106, among others. In some embodiments, the communications controller 2500 can provide a status message to the electricity service provider and/or the remote monitoring system to indicate a status of the BESS unit as described herein. In these embodiments, the status message can indicate the BESS unit is operating normally without detecting any errors, faults, failures, performance degradation, and/or maintenance needs or not operating normally having errors, faults, failures, performance degradation, and/or maintenance needs. In some embodiments, the communications controller 2500 can provide the status message to the electricity service provider and/or the remote monitoring system at discrete intervals in time, for example, multiple times every day, once every few minutes, once every hour, once every few hours, once every day, once every couple of days, once every week, once every couple of weeks, once every month, and/or once every couple of months to provide some examples. As illustrated in FIG. 1, the communications controller 2500 can include a processor 2502, a memory 2504, wired data ports 2522, wireless data ports 2524, a power converter 2526, a control module 2528, and an input/output controller 2530. The communications controller 2500 can represent an exemplary embodiment of the communication controller 1104 described herein.

The processor 2502 controls overall configuration and/or operation of the communications controller 2500. In some embodiments, the processor 2502 manages and/or directs the behavior and/or the interaction of the communications controller 2500 with the BESS unit, the electricity service provider, and/or the remote monitoring system. Generally, the processor 2502 can perform various operations, such performing calculations, data processing, and/or coordinating the activities of the communications controller 2500, among others. In some embodiments, the communications controller 2500 can execute one or more instructions of one or more software programs, handle complex tasks, and ensure that data flows correctly through the communications controller 2500. In these embodiments, the processor 2502 can operate in a continuous loop to execute these instructions, coordinate with the communications controller 2500, and produce outputs as outlined in the one or more software programs. In these embodiments, the continuous loop allows the processor 2502 to repeatedly perform various operations, such performing calculations, data processing, and/or coordinating the activities of the communications controller 2500, among others.

In the exemplary embodiment illustrated in FIG. 25, the processor 2502 can access one or more characteristics, parameters, and/or attributes of the BESS unit. As illustrated in FIG. 25, the processor 2502 can receive the one or more characteristics, parameters, and/or attributes from the wired data ports 2522 and/or the wireless data ports 2524. In some embodiments, the processor 2502 can write the one or more characteristics, parameters, and/or attributes to the memory 2504. Alternatively, or in addition to, the processor 2502 can read the one or more characteristics, parameters, and/or attributes from the memory 2504. In some embodiments, these characteristics, parameters, and/or attributes can include characteristics, parameters, and/or attributes that are monitored by a battery management system (BMS) and/or a power converter. In these embodiments, those characteristics, parameters, and/or attributes that are monitored by the BMS can include characteristics, parameters, and/or attributes related to health, charge levels, and/or safety parameters, among others, such as State of Charge (SOC), State of Health (SOH), Voltage, Current, Temperature, Cycle Count, Capacity, Internal Resistance, Fault Detection, Charge/Discharge Rates, State of Power (SOP), Cell Balancing, and/or Ambient Conditions, among others. In these embodiments, those characteristics, parameters, and/or attributes that are monitored by the power converter can include characteristics, parameters, and/or attributes related to energy conversion, power flow, voltage and current regulation, and ensuring safe operation with the electricity service provider, such as Voltage, Current, Power Flow, Efficiency, Temperature, Power Factor, Frequency, DC-Link Voltage, Harmonics, Overvoltage and Undervoltage Protection, Overcurrent Protection, Fault Detection and Diagnostics, Inverter Synchronization, and/or Load Demand. In some embodiments, these characteristics, parameters, and/or attributes can include characteristics, parameters, and/or attributes communicated between the BMS and the power converter, such as State of Charge (SOC), State of Health (SOH), Voltage, Current, Temperature, Charge/Discharge Rates, Fault Alerts, State of Power (SOP), Cell Balancing Status, and/or Ambient Conditions, among others. Alternatively, or in addition to, the processor 2502 can derive the characteristics, parameters, and/or attributes of the BESS unit from those characteristics, parameters, and/or attributes that are monitored by the BMS and/or those characteristics, parameters, and/or attributes that are monitored by the power converter, such as Remaining Battery Capacity, Battery Charge/Discharge Efficiency, Battery Power Output, Battery Aging Rate, State of Health (SOH) Rate, Energy Efficiency, Peak Power Demand, Estimated Battery Lifetime, Real Power, Apparent Power, Reactive Power, Conversion Efficiency, Power Factor, Grid Synchronization Quality, Harmonic Distortion Level, Load Power Demand, Overload Duration, and/or Fault Event Duration, among others.

In the exemplary embodiment illustrated in FIG. 25, the processor 2502 can analyze the one or more characteristics, parameters, and/or attributes to detect errors, faults, failures, performance degradation, and/or maintenance needs. In some embodiments, the processor 2502 can detect errors, faults, failures, and performance degradation early on, allowing for preventive maintenance, ensuring optimal performance, and beneficially extending the operational life of the BESS unit. In the exemplary embodiment illustrated in FIG. 25, the processor 2502 can monitor the one or more characteristics, parameters, and/or attributes for threshold violation, for example, over voltage, under voltage, over current, under current, and/or over temperature, among others, analyze the one or more characteristics, parameters, and/or attributes for unexpected changes or gradual trends that suggest degradation of the BESS unit, and/or predict maintenance needs based on usage patterns and system trends. In these embodiments, the processor 2502 can detect the errors, faults, failures, for example, when these characteristics, parameters, and/or attributes exceed or fall below a predefined safe operating range, change unexpectedly, show abnormal fluctuations, and/or fail to return to normal after a transient event, among others. In these embodiments, the processor 2502 can detect the performance degradation when these characteristics, parameters, and/or attributes exhibit a consistent decline, for example, a decrease in efficiency, an increase loss in power conversion, and/or a decline in available capacity, among others. In these embodiments, the processor 2502 can identify maintenance needs by tracking these characteristics, parameters, or attributes over time to detect trends or deviations that indicate when maintenance might be needed.

In some embodiments, the processor 2502 can generate one or more alarms or error codes in response to detecting errors, faults, failures, performance degradation, and/or maintenance needs. In these embodiments, these alarms or error codes provide clear and actionable notifications of potential issues or abnormal conditions presented in the BESS unit and can play a crucial role in maintaining the health, safety, and performance of the BESS unit by enabling early detection of faults, reducing downtime, and informing maintenance strategies. In some embodiments, the error codes can represent numeric or alphanumeric values generated by the processor 2502 to represent specific errors, faults, failures, performance degradation, and/or maintenance needs within the BESS unit. In these embodiments, each error code corresponds to a specific errors, faults, failures, performance degradation, and/or maintenance need, such as overvoltage, overcurrent, temperature thresholds, or communication failures allowing for precise troubleshooting of the BESS unit. In these embodiments, the error codes can have different severity levels, such as warnings (non-critical) or faults (critical), among others, allowing these error codes to be prioritized. In some embodiments, the one or more alarms can be used to notify about the detection of errors, faults, failures, performance degradation, and/or maintenance need. In these embodiments, these alarms can include visual alarms, for example, flashing lights, icons on the display panel, or a warning indicator on a user interface, among others, auditory alarms, for example, beeps, buzzers, and/or sirens, among others, and/or remote notifications, for example, sent remotely via text messages, emails, or system notifications, among others.

After detecting errors, faults, failures, performance degradation, and/or maintenance needs, the processor 2502 can generate the status message to indicate the BESS unit is not operating normally having errors, faults, failures, performance degradation, and/or maintenance needs. In some embodiments, the processor 2502 can generate the negative status message, such as the “not OK message,” to indicate that it has detected the errors, faults, failures, performance degradation, and/or maintenance needs. In these embodiments, the negative status message can include the one or more characteristics, parameters, and/or attributes and/or the one or more alarms or error codes, among others, that can be used to diagnose and/or address issues preventing its normal operation. In the exemplary embodiment illustrated in FIG. 25, the processor 2502 can include an error timer that expires, for example, multiple times every day, once every few minutes, once every hour, once every few hours, once every day, once every couple of days, once every week, once every couple of weeks, once every month, and/or once every couple of months to provide some examples. In some embodiments, the error timer can reset upon detecting the errors, faults, failures, performance degradation, and/or maintenance needs. In these embodiments, the processor 2502 can generate, in response to expiration of the error timer, the status message to indicate the BESS unit is operating normally without errors, faults, failures, performance degradation, and/or maintenance needs. For example, the processor 2502 can generate, in response to expiration of the error timer, the positive status message, such as the “OK message,” to indicate that it is operating normally without detecting any errors, faults, failures, performance degradation, and/or maintenance needs. In some embodiments, the processor 2502 can provide the status message to the wired data ports 2522 and/or the wireless data ports 2524 for delivery to the remote monitoring system.

The memory 2504 ensures the smooth operation and functionality of the communications controller 2500 by maintaining access to the one or more software programs and the one or more characteristics, parameters, and/or attributes. In some embodiments, the memory 2504 generally refers to any mechanism or device to store information in a form that can be accessed and processed by a machine, for example, the processor 2502. In these embodiments, the memory 2504 often plays a vital role in the operation of the communications controller 2500, enabling the processor 2502 to execute the one or more instructions of the one or more software programs and/or store relevant data during their execution. In some embodiments, the memory 2504 can include various types of storage technologies, each serving specific purposes depending on requirements of the communications controller 2500. In these embodiments, the memory 2504 can include read only memory (ROM), random access memory (RAM), magnetic disk storage media, optical storage media, and/or flash memory devices, among others. In some embodiments, the memory 2504 can be responsible for storing the one or more instructions and/or data required for execution of the one or more software programs and/or the one or more characteristics, parameters, and/or attributes, among others. The memory 2504 facilitates efficient storage and retrieval of the one or more characteristics, parameters, and/or attributes, allowing the processor 2502 to perform necessary tasks such as adjusting settings, optimizing performance, or troubleshooting potential issues.

The wired data ports 2522 and/or the wireless data ports 2524 represent various hardware or software-based communication interfaces to connect the communications controller 2500 to the BESS unit, the electricity service provider, and/or the remote monitoring system. Generally, the wired data ports 2522 and/or the wireless data ports 2524 can include physical data ports, such as Universal Serial Bus (USB) Ports, Ethernet Ports, High-Definition Multimedia Interface (HDMI) ports, Thunderbolt Ports, Serial Ports, Parallel Ports, Controller Area Network (CAN) bus Ports, and/or DisplayPorts, among others; and/or virtual data ports for data communication over networks, such as Transmission Control Protocol/Internet Protocol (TCP/IP) Ports, Secure Shell (SSH) Ports, File Transfer Protocol (FTP) Ports, and/or Domain Name System (DNS) ports, Wi-Fi Data Ports, Bluetooth Data Ports, among others. In some embodiments, the wired data ports 2522 represent hardware or software-based wired communication interfaces to connect the communications controller 2500 to the BESS unit, the electricity service provider, and/or the remote monitoring system. As illustrated in FIG. 25, the wired data ports 2522 can include an RS-485 communications port 2506, a USB port 2507, a CANBus port 2508, and a TCP/IP port 2510. In some embodiments, the wireless data ports 2522 represent hardware or software-based wired communication interfaces to connect the communications controller 2500 to the BESS unit, the electricity service provider, and/or the remote monitoring system. As illustrated in FIG. 25, the wireless data ports 2522 can include a Wi-Fi Port 2512. In some embodiments, the wireless data ports 2522 can be coupled to, and/or can include, one or more wireless hardware layers, often referred to as physical layers (PHYs), to provide the physical transmission of radio signals with the BESS unit, the electricity service provider, and/or the remote monitoring system, among others.

The power converter 2526 can provide the needed by the communications controller 2500 to function as described herein. In some embodiments, the power converter 2526 can convert one or more forms of electrical power, for example, alternating current (AC) power provided by the electricity service provider and/or direct current (DC) power provided by the BESS unit, into one or more other forms, for example, DC power, as illustrated in FIG. 25. In the exemplary embodiment illustrated in FIG. 25, the communications controller 2500 may require different voltage levels, currents, and power specifications than those provided by the electricity service provider and/or the BESS unit. In some embodiments, the power converter 2526 can step up the power provided by the electricity service provider and/or the power provided by the BESS unit, step down the power provided by the electricity service provider and/or the power provided by the BESS unit, and/or provide isolated power levels. In these embodiments, the power converter 2526 can include one or more linear regulators, switching regulators, DC-DC converters, AC-DC converters, Power over Ethernet (POE) Integrated Circuits (ICs), and/or Integrated Power Management ICs (PMICs), among others.

The control module 2528 can manage the flow of electricity between different parts of the BESS unit, for example, connecting or disconnecting batteries, inverters, or other power circuits. In some embodiments, the control module 2528 allows for the remote or automated control of one or more relays 2520, providing flexibility and enabling monitoring and safety features. In these embodiments, the control module 2528 can include digital input/output interfaces and relay drivers that operate in accordance with various industrial communication protocols. In these embodiments, the digital input/output interfaces uses digital signals to control operation of the one or more relays 2520. For example, the processor 2502 can provide one or more digital logic signals to the one or more relays 2520, activating or deactivating the one or more relays 2520. In these embodiments, the relay drivers can provide sufficient current and voltage to the one or more relays 2520. For example, the one or more digital logic signals may not have enough power to directly control the one or more relays 2520, so the relay drivers, for example, MOSFETs, can be used to amplify the one or more digital logic signals to activate or deactivate the one or more relays 2520.

The input/output controller 2530 operates as a peripheral device controller that manages and controls one or more peripheral devices connected to the BESS unit. These peripheral devices may include printers, mice, keyboards, monitors, storage devices, and/or scanners, among others. In some embodiments, the input/output controller 2530 facilitates communication between these peripheral devices and the processor 2502, enabling data exchange between them. For example, the input/output controller 2530 ensures that data from the peripheral devices is transferred to the memory 2504 or directly to the processor 2502 for processing. In some embodiments, these peripheral devices and the processor 2502 can use different data formats. In these embodiments, the input/output controller 2530 can convert or translate the data to ensure smooth operation. Additionally, these peripheral devices can generate interrupts during their operation. In some embodiments, the input/output controller 2530 can handle these interrupts and manages the priority of these peripheral devices. In some embodiments, the input/output controller 2530 may include, or be coupled to, buffers or memory storage to temporarily hold data during communication to prevent data loss or corruption.

In the exemplary embodiment illustrated in FIG. 25, the communications controller 2500 can include a Micro Secure Digital (MicroSD) Card 2514, a MicroSD Reader 2516, and a watchdog timer (WDT) 2518. In some embodiments, the WDT 2518 can be implemented as a Hardware Watchdog and/or Software Watchdog to monitor the operation of the processor 2502, ensuring it operates correctly. In these embodiments, the WDT 2518 triggers a system reset, or other corrective actions, to restore normal operation in response to the processor 2502 failing to reset the watchdog timer within a predefined time period. For example, the WDT 2518 can be set to a specific timeout period. In this example, if the processor 2502 does not reset the WDT 2518 before expiration of the specific timeout period, the WDT 2518 assumes the processor 2502 has become unresponsive and initiates a corrective action. In some embodiments, the corrective action can include reverting to one or more previous versions of the one or more software programs. In these embodiments, the processor 2502 can restore an earlier, stable version of the one or more software programs when the current version encounters issues like bugs, crashes, or performance degradation. This approach is commonly used when new updates or changes introduce unintended problems, and it is critical for ensuring that the communications controller 2500 continues functioning properly while issues are resolved. As illustrated in FIG. 25, the MicroSD Reader 2516 can be coupled to the MicroSD Card 2514. In the exemplary embodiment illustrated in FIG. 25, the MicroSD Card 2514 represents a portable memory storage device to store data and the MicroSD Reader 2516 allows the processor 2502 to read and/or write the data to MicroSD Card 2514. In some embodiments, the MicroSD Card 2514 can to store the previous versions of the one or more software programs. In these embodiments, the MicroSD Reader 2516 can read these versions of the one or more software programs from the MicroSD Card 2514. Alternatively, or in addition to, the MicroSD Card 2514 can represent an extension of the memory 2504 that can be used to store the one or more characteristics, parameters, and/or attributes, among others. In some embodiments, the MicroSD Reader 2516 can write the one or more characteristics, parameters, and/or attributes to the MicroSD Card 2514. Alternatively, or in addition to, the MicroSD Reader 2516 can read the one or more characteristics, parameters, and/or attributes from the MicroSD Card 2514.

FIG. 26A illustrates an example communication controller 2600 having a communication circuit 2600 that is used for remote monitoring, maintenance, and control of BESS units according to an embodiment of the present disclosure. The communication controller 2600 further illustrates an exemplary embodiment of the communications controller 2500 as described herein.

FIG. 26B illustrates an example communications controller 2650 for a battery energy storage system with remote monitoring, maintenance, and control according to an embodiment of the present disclosure. Communication controller 2650 includes several data structures (DS) as shown in FIG. 26B. For example, as shown in FIG. 26B, data structure 1 (DS-1) stores all the BMS 1106 data. Data structure 2 (DS-2) storages all the data communicated between BMS 1106 and inverter or power converter 1102. Data structure 3 (DS-3) stores all the power converter 1102 data. In embodiments, less than all of the BMS 1106 and power converter 1102 data may be stored in data structures of communication controller 2650.

In embodiments, software running on communication controller 2650 reads data from BMS 1106 and power converter 1102 and stores it in one or more data structures residing on communication controller 2650. Software running on communication controller 2650 also sends data from one or more data structures on communication controller 2650 to BMS 1106 and power converter 1102. This data transfer can use CANbus communications and/or RS-485 communications as shown in FIG. 26B. Other communications protocols can also be used. In an embodiment, communication controller 2650 monitors and stores the data transmitted by BMS 1106 to power converter 1102.

As shown in FIG. 26B, in embodiments of the present invention, communication controller 2650 also communicates with a smartphone 1502 and a PUD/utility controller 2652. The smartphone 1502 allows a user to set and control the operation of the battery energy storage unit. PUD/utility controller 2652 can also control the battery energy storage unit and override the settings and controls sent by smartphone 1502. In embodiments, as described below in more detail, communication controller 2650 can receive control information from PUD/utility controller 2652 that controls the charging and discharging of the battery energy storage system unit as well as the amount of power that may be feed back to the grid by the batteries and/or solar panels of the battery energy storage unit. In embodiments, smartphone 1502 communicates with communication controller 2650 using Bluetooth communications or TCP/IP communications. In embodiments, PUD/utility controller 2652 communicates with communication controller 2650 using TCP/IP communications. Other communication protocols may also be used.

As shown in FIG. 26B, data stored in the data structures of communication controller 2652 are communicated to a remote monitoring and control server 2654 and displayed on one or more graphical user interfaces (GUIs) of a remote monitoring and control computer 2656. In embodiments, remote monitoring and control server 2654 communicates with communication controller 2650 using TCP/IP communications. Other communication protocols may also be used.

In an embodiment, the data from the different data structures of communication controller 2650 are displayed on different GUIs of remote monitoring and control computer 2656.

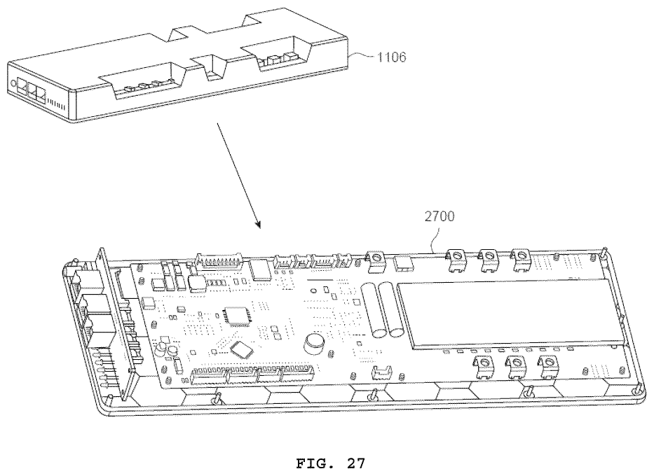

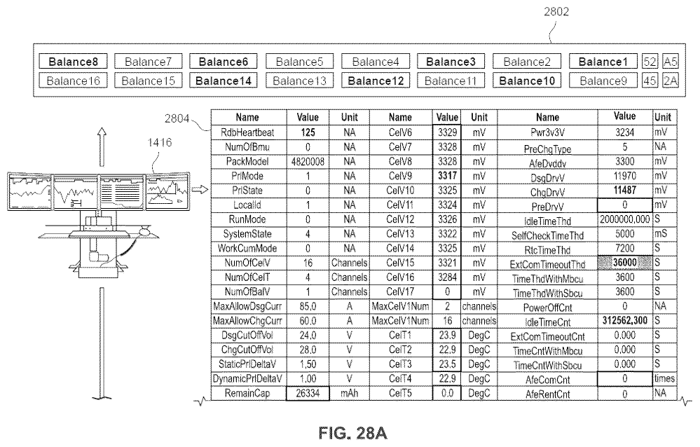

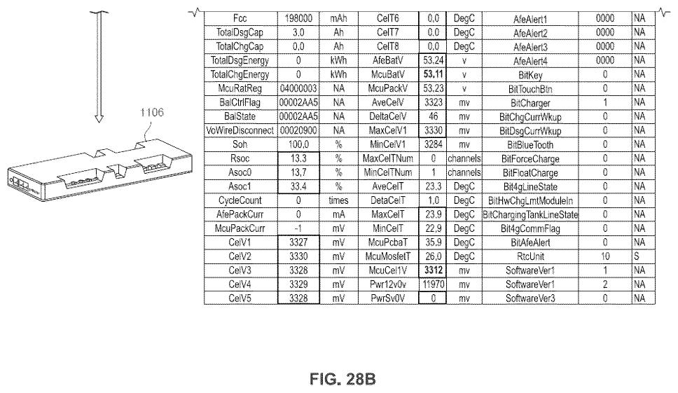

FIGS. 27, 28A, and 28B illustrate an example battery management system 1106 having a battery management circuit 2700 for a battery energy storage system with remote monitoring, maintenance, and control according to an embodiment of the present disclosure. FIG. 27 shows an embodiment of battery management circuit 2700. FIGS. 28A, and 28B further illustrates BMS 1106. As shown in FIGS. 28A, and 28B, in an embodiment, BMS data is communicated to monitoring center computer 1416, and the BMS data is displayed for an operator to view using example GUIs 2802 and 2804. The GUIs display such data, for example, as battery cell voltages and temperatures as well as which battery cells are currently being balanced.

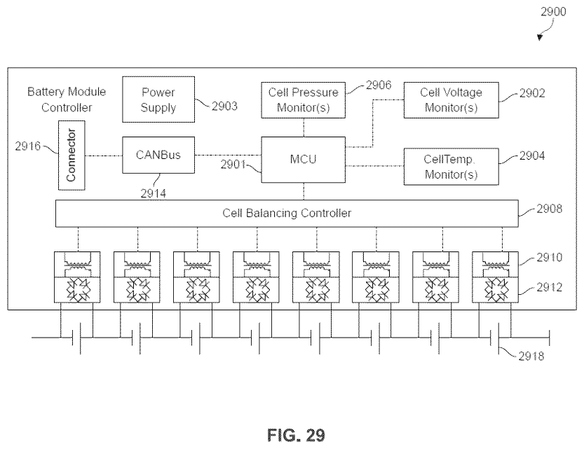

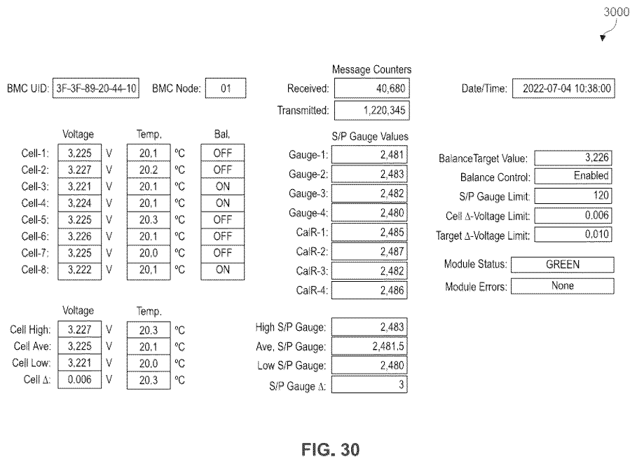

FIG. 29-30 illustrate an example battery management system 2900 for a battery energy storage system with remote monitoring, maintenance, and control according to an embodiment of the present disclosure. In embodiments, battery management system 2900 is the same or similar to the battery management system described, for example, in U.S. patent application Ser. No. 17/531,378, Filed Nov. 19, 2021, Titled “Battery Module and Battery Rack with Enhanced Fire Safety Features, and Applications Thereof,” and U.S. patent application Ser. No. 18/343,864, Filed Jun. 29, 2023, Titled “Pressure Sensors and Circuits for Preventing Battery Fires, and Applications Thereof,” both of which are incorporated herein by reference in their entireties.

As shown in FIG. 29, in an embodiment, battery management system 2900 includes a power supply 2903, a microcontroller unit (MCU) 2901, cell voltage monitors 2902, cell temperature monitors 2904, cell pressure monitors 2906, a cell balancing controller 2908, balancing transformers 2910, and balancing rectifiers 2912. In an embodiment, MCU 2901 communicates with a higher-level controller using a CANBus communications controller 2914. The CANBus communications controller is connected to the higher-level controller using a connector 2916. In an embodiment, the higher-level controller is a battery system controller such as communications controller 1104.

In operation, power supply 2903 draws power from a power grid and/or battery cells of a battery module and converts this power to AC power and DC voltages needed to operate the components of battery module controller 2900. The AC power output by power supply 2904 is supplied to the cell balancing transformers 2910 and balancing rectifiers 2912 for balancing cells 2918. Power supply 2903 produces DC power required to operate the various components of battery management circuit board 2900 such as, for example, MCU 2901, cell voltage monitors 2902, cell temperature monitors 2904, cell pressure monitors 2906, and cell balancing controller 2908. MCU 2901 runs the firmware and software that controls the operation and functions of battery management circuit board 2900. These functions include monitoring the voltage, temperature and pressure of the battery cells that make up a battery module controlled by battery management circuit board 2900. The functions also include balancing the battery cells of the battery module and communicating data about the battery module and battery cells to a higher-level controller such as, for example, a battery system controller as described below. Cell voltage monitor(s) 2902, cell temperature monitor(s) 2904, and cell pressure monitor(s) 2906 are the hardware sensors and circuits needed to monitor the battery cell voltages, temperatures, and pressures. Cell balancing controller 2908 is the hardware needed to provide balancing current/power to the individual battery cells 2918 of the battery module controlled by battery management circuit board 2900. As will be understood by persons skilled in the relevant art(s), hardware other than that described herein can be used to monitor battery cell voltages and temperatures, and to balance battery cells of a battery module according to the present disclosure.

FIG. 30 illustrates an example battery management system graphical user interface (GUI) 3000 according to an embodiment of the present disclosure. The values displayed on GUI 3000 illustrate the firmware and/or software running, for example, on battery management system 2900.

Starting in the top left corner of GUI 3000, the GUI displays a unique ID (BMC UID) for the battery module controller and a Node ID. In embodiments, the unique ID is the serial number of the processor of the battery module controller. The Node ID is an assigned ID used to identify the battery module controller CANBus messages sent to a higher-level battery rack or battery system controller.

Below the identification fields in GUI 3000 are the fields displaying the battery cell voltages, battery cell temperatures, and the battery cell balancing states. In embodiments, the cell voltages are displayed in millivolts. The cell temperatures are displayed in tenths of a degree Celsius. The balancing state is either on, meaning the cell is currently balancing, or off, meaning the cell is not currently balancing. Below these fields are the cell high, average, and low voltage and temperatures fields. In order to reduce the number of messages normally sent by the battery module controller to the higher-level controller, in embodiments the battery module controller sends these calculated values rather than the measured values. These calculated values are sufficient to safely monitor and manage the battery cells. Also shown are fields for the highest cell voltage and temperature; the average cell voltage and temperature; the lowest cell voltage and temperature; and the difference between the highest cell voltage and cell temperature and the lowest cell voltage and cell temperature, respectively.

At the top middle section of GUI 3000, two fields display the number of messages received by the battery module controller and the number of messages sent by the battery module controller. These displayed message counts show that the battery module controller is active and communicating.

Below the message count fields are the swelling/pressure (S/P) gauge values and the gauge calibration values. The S/P gauge values are used to determine whether any of the battery cells have an issue and thus indicate that the battery module should be disconnected from the battery system DC bus to prevent a battery fire. A battery cell can swell, for example, due to the liquid electrolyte in the battery cell decomposing into explosive and hazardous gases before it vents and catches on fire. Thus, in embodiments of the present disclosure, the battery management system continuously monitors every battery module for swelling and/or the presence of increased pressure in one or more cells of a battery module, and when this is detected, the battery module is disconnected from the battery system so that it can no longer be charged and/or discharged in order to prevent further damage to a battery cell and to prevent a battery fire.

In embodiments of the present disclosure, one or more calibration resistors are measured and used to calibrate the S/P gauge values obtained by the battery module controller. These calibration measurements ensure the accuracy of the S/P gauge values used to monitor for battery cell swelling or the presence of increased pressure in one or more cells of a battery module. The last field in the middle section of GUI 700 shows the highest S/P gauge reading; the average S/P gauge reading; the lowest S/P gauge reading; and the difference between the highest S/P gauge reading and the lowest S/P gauge reading.

On the top right side of GUI 3000, the date and time of the last data received from the battery module controller is displayed. This date and time can continually update and is an indication of how old the data is that is displayed on the GUI.

Below the date and time values are several fields displaying control values and status values. The control values include a balance target value, a balance control value, an S/P gauge limit value, a cell voltage difference limit value, a target cell voltage difference limit value, and a cell temperature difference limit value. The balance target value is the value that the battery module controller uses to control battery cell balancing. The balance control value indicates whether battery cell balancing is enabled or disabled. The three limit values (i.e., S/P gauge limit, cell Δ-voltage limit, and cell Δ-temperature limit) are used to determine whether the battery module is operating in a safe and desired condition. The module status value gives a quick indication of the overall operating status of the battery module (such as “GREEN” to indicate the battery module is operating properly, “YELLOW” to indicate the batter module has a minor operating issue, and “RED” to indicate the battery module has a major operating issue), and the module error field can display an error code to indicate whether there are any current issues with the battery module.

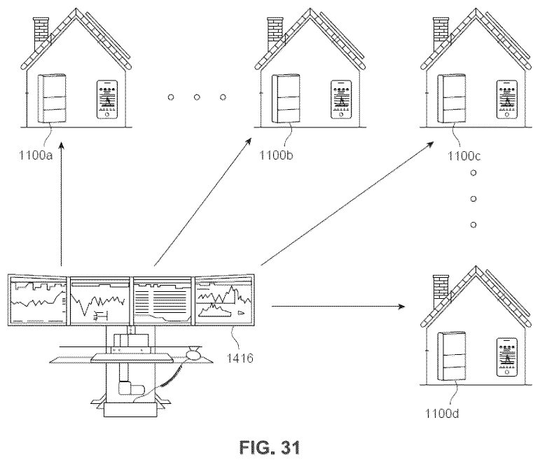

FIG. 31 illustrates a monitoring center computer 1416 being used to monitor, maintain, and control the operation of multiple BESS units 1100a-d according to an embodiment of the present disclosure. In an embodiment, a public utility district (PUD) electric utility can use BESS system 1500, as described herein, to lower its demand charges and thereby provide electricity to its members at a reduced rate.

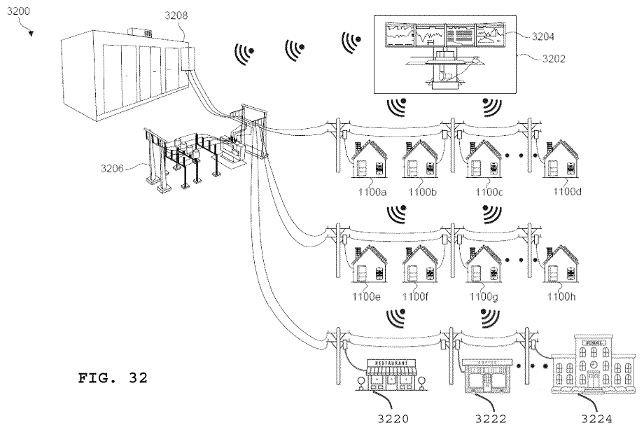

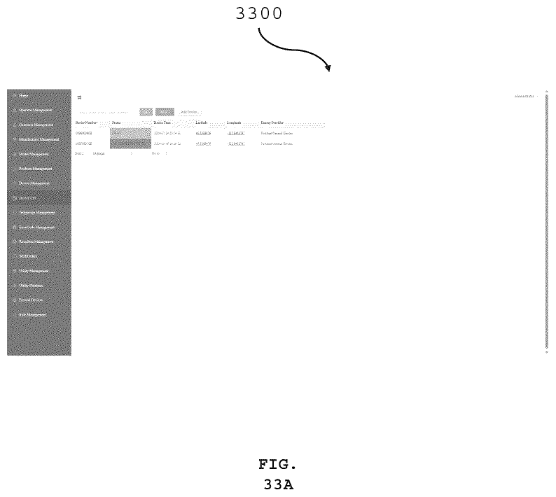

FIG. 32 illustrates a system 3200 for integrating battery energy storage systems into an electrical distribution system, such as for example an electrical distribution system owned and operated by a public utility district (PUD) or other entity. In an embodiment, system 3200 includes a monitoring and control computer 3204 located in a control center 3202 (e.g., a monitoring center of a PUD), at least one battery energy storage system (BESS) located at a substation 3206, and a number of residential BESS units 1100a-n located at customer sites (e.g., the homes of PUD customers). The BESS units are monitored and sent control signals using monitoring and control computer 3204.

In operation, each of the residential BESS units 1100 stores electrical energy. This energy can come from the grid and/or from solar panels. The power conversion system of each BESS unit 1100 controls the flow and use of energy stored in the batteries of each BESS unit 1100. The energy can be used to power customer loads, or it can be fed back to the grid. Each residential BESS unit has programmable control settings that limit the amount of power that can be drawn from the grid and that limit the amount of power that can be fed back to the grid. These programmable settings can be controlled and set in real-time by monitoring and control computer 3204. For example, when the PUD does not want any power fed back to the distribution system, or wants to limit the amount of power fed back to the distribution system so that no power if fed from substation 3206 to the system supplying power to substation 3206, the PUD can use monitoring and control computer 3204 to send signals to the BESS units commanding them not to feed any power back to the grid or to reduce the amount of power they are feeding back to the grid. Having an ability to control and set the amount of power each of the residential BESS units can feed back to the grid should allow a PUD or other utility entity to increase the number of interconnections that are allowed, reduce the time needed to approve an interconnection application, and reduce the backlog of interconnection applications. Also, by increasing the number of interconnections that are granted and speeding up the interconnection approval time, the PUD or other utility entity can increase the number of controllable assets available to it to so that it can more efficiently use its distribution system and increase it resilience. The utility customers can also benefit from having on-site backup power available from the BESS units when needed and, for example, in the case of a PUD, lower electricity costs.

Typically, a distribution system operator such as a PUD or a municipal electrical utility can pay demand charges, for example, based on the peak power drawn at a substation. In embodiments of the present disclosure, system 3200 can be used by these entities to lower these demand charges by sending commands using monitoring and control computer 3204 to the residential BESS units 1100 that control when the batteries of the BESS units are charged and discharged. These commands can be used, for example, to ensure the batteries are only charged using grid power during off-peak times, and to discharged power back to the distribution system as needed during periods of peak electrical demand, thereby reducing the amount of demand charges that are incurred.

As shown in FIG. 32, in embodiments, system 3200 includes a BESS unit 3208. BESS unit 3208 is a larger BESS unit located at or next to substation 3206. BESS unit 3208 is also monitored and controlled by monitoring and control computer 3204. In embodiments, BESS unit 3208 is a containerized commercial & industrial sized or utility sized BESS unit.

In operation, in embodiments, BESS unit 3208 acts as a buffer to prevent power from being fed from substation 3206 to the utility system supplying power to substation 3206. A power meter in substation 3206 provides data regarding power flow and the amount of power being supplied by substation 3206 to local customers. This data is also provided to monitoring and control computer 3204. If more power should start being produced by customers connected to the distribution system (e.g., by solar panels at customer sites) than is being consumed by all the customers connected to the distribution system, a signal is sent to BESS unit 3208 to start charging its battery and prevent power from being back-fed from substation 3206 to the utility supplying power to the substation. Then, as needed, commands are sent from monitoring and control computer 3204 to the residential BESS unit to reduce, limit, or stop them from feeding power back to the distribution system.

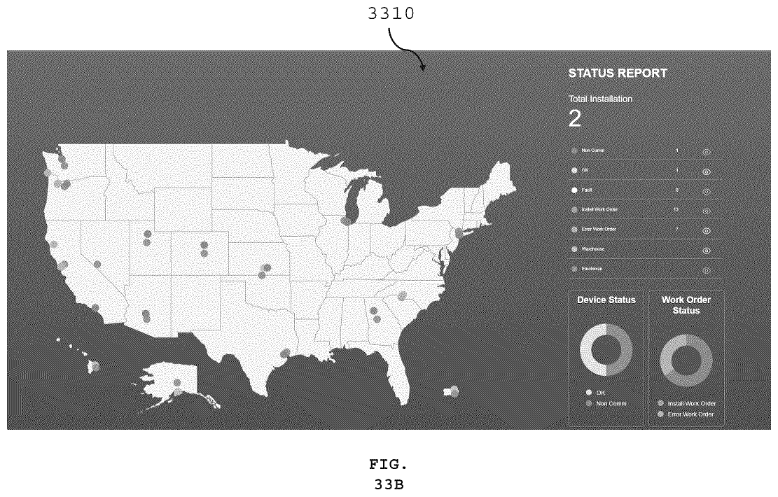

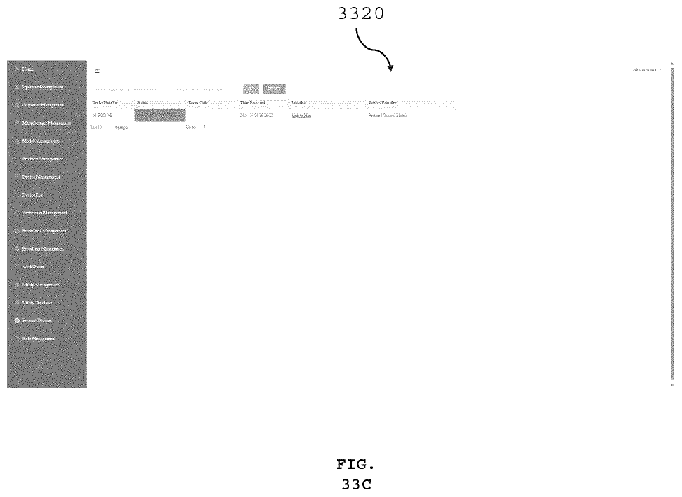

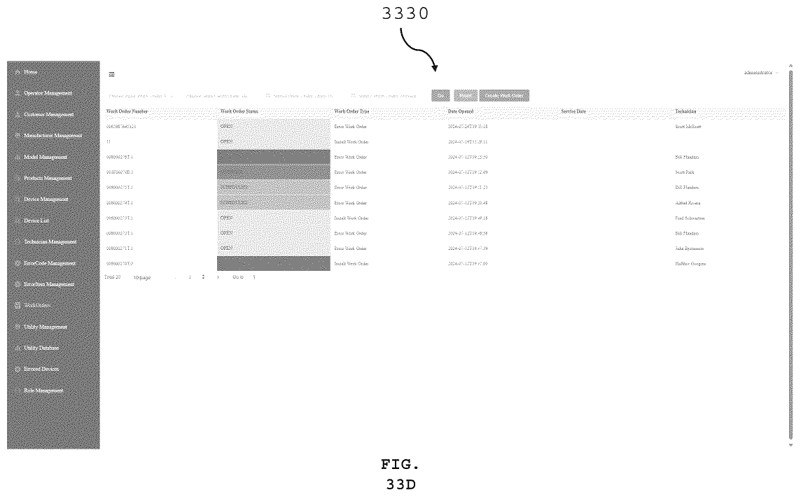

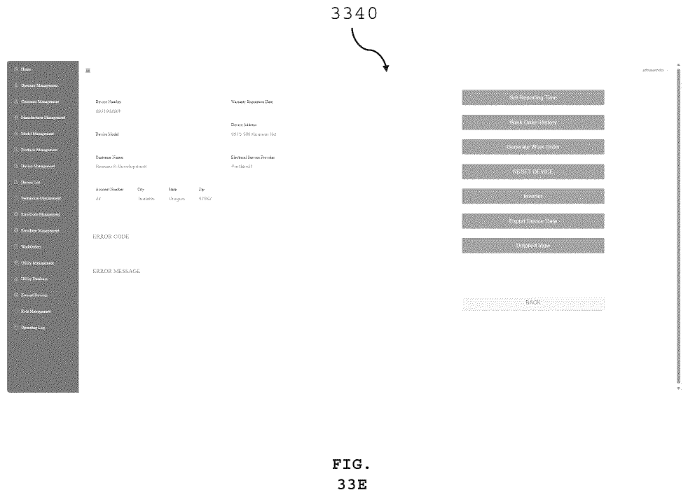

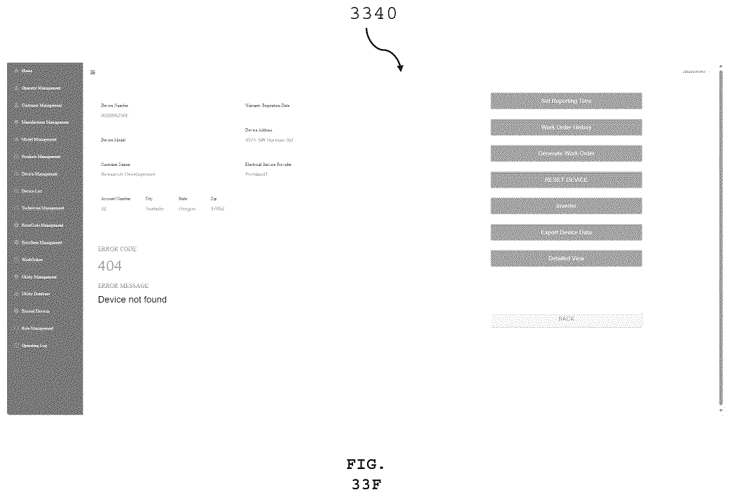

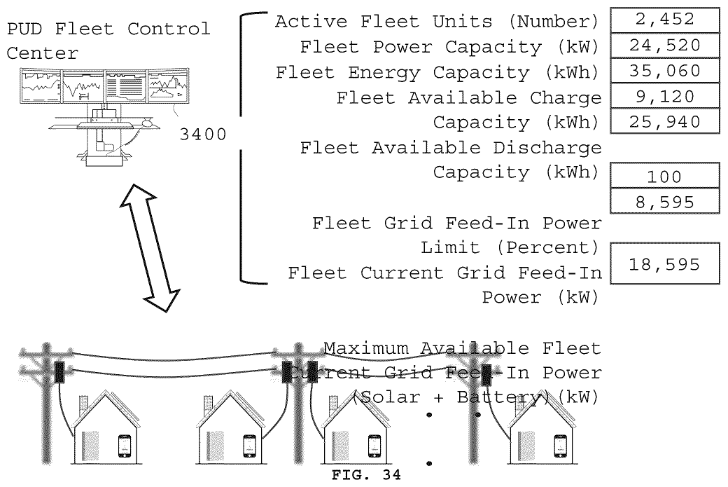

FIGS. 33A-F illustrate example graphical user interfaces of a remote battery energy storage monitoring and maintenance system according to an embodiment of the present disclosure.

FIG. 33A illustrates a device management graphical user interface (GUI) 3300 according to an embodiment of the present invention. GUI 3300 displays for example a list of all BESS units 1100 installed in the United States. GUI 3300 is displayed for example on monitoring center computer 1416. The GUI 3300 displays all devices that have been connected to the remote monitoring system.

FIG. 33B illustrates a device map GUI 3310 according to an embodiment of the present invention. GUI 3310 displays for example a list of all BESS units 1100 installed in the United States. GUI 3300 is displayed for example on monitoring center computer 1416. The GUI 3300 displays devices connected to the RMS and their last reported status, error and install work orders, warehouses, electricians. The GUI 3300 includes a legend that doubles as filters and charts at the bottom display ratio of device statuses and work order statuses. In an embodiment, GUI 3310 displays BESS units 1100 monitored by the remote battery energy storage monitoring and maintenance system and their last reported status, any present errors and work orders, warehouses where BESS units are stored as well as repair parts for the BESS units 110, and the locations of field electricians available to install a BESS unit 1100 or to repair one needing maintenance. GUI 3310 includes a legend that summarizes the status of the monitored BESS units 1100 and the status of pending work orders.

FIG. 33C illustrates a device errors graphical user interface (GUI) 3320 according to an embodiment of the present invention. GUI 3320 displays for example a list of all BESS units 1100 installed in the United States that have an error. GUI 3320 is displayed for example on monitoring center computer 1416. The GUI 3320 automatically filters out working devices from the full device list and prioritizes them both by time of error and fault vs not communicating.

FIG. 33D illustrates a work order management graphical user interface (GUI) 3330 according to an embodiment of the present invention. GUI 3330 displays for example a list of all work orders pending for BESS units 1100 installed in the United States or waiting to be installed. GUI 3330 is displayed for example on monitoring center computer 1416. In an embodiment, GUI 3330 displays the status of all pending work orders and allows for the work orders to be filtered by work order type, scheduled date, work order number, and field electrician assigned to the work order. The GUI 3330 acts as a repository of completed work orders and list for managing active work orders. It displays status of work orders and allows filtering by work order type, scheduled date, work order number and assigned electrician company.

FIG. 33E illustrates a BESS unit information graphical user interface (GUI) 3340 according to an embodiment of the present invention. GUI 3340 displays for example a list of information for a selected BESS unit 1100 installed in the United States. GUI 3340 is displayed for example on monitoring center computer 1416. The GUI 3340 displays details about device, including customer information and error information. Buttons on the side allow for remote reset of device, generating a work order, checking the work order history, as well as a detailed view of the current device status. Information about a selected BESS unit 1100 displayed on GUI 3340 includes customer information, error information, and work order information. Buttons on GUI 3340 allow for a remote reset of the selected BESS unit 1100, generation of a work order for the selected BESS unit 1100, and the current status of the selected BESS unit 1100.

FIG. 33F illustrates GUI 3340 for a BESS unit 1100 that is not communicating with the remote battery energy storage monitoring and maintenance system. As shown in GUI 3340, an error code 404 is displayed as well as details about the last received communication from the BESS Unit 1100. The GUI 3340 represents a device details screen with not communicating error. Error code and error details are provided when the last received message is not an OKAY message.

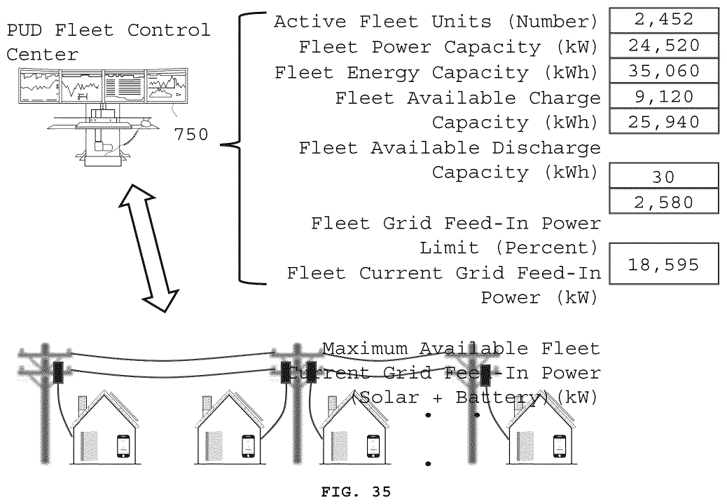

FIGS. 34-36 illustrate Public Utility District (PUD) or utility control of a fleet of battery energy storage system units 1100a-n according to an embodiment of the present invention. As shown, for example, in FIG. 34, the operation of battery energy storage system units 1100a-n is controlled by a PUD fleet control center 3400.

In an embodiment, one or more monitors of PUD fleet control center 3400 display the data shown in FIGS. 34-36. This data includes the number of active fleet units being controlled by the PUD, the power capacity of these fleet units, the energy storage capacity of these fleet units, the available charge capacity of these fleet units, and the discharge capacity of these fleet units. Also displayed is the current feed-in power limit being used to control how much power may be feed back to the grid and the current power being feed back into the grid. Also included in embodiments of the present invention is the total power that can be feed back to the grid on demand, for example, by discharging the batteries of the fleet units and by sending power from the solar panels of the fleet units to the grid.

FIG. 35 illustrates a case where the PUD wants to limit the power being feed back to the grid by the fleet units. In this case, the PUD sends a power limit of 30% to the fleet units, and the power feed back to the grid by the fleet units changes from 8,595 kW to 2,580 kW. This reduces the power being feed back to the grid by the fleet units by 70%.

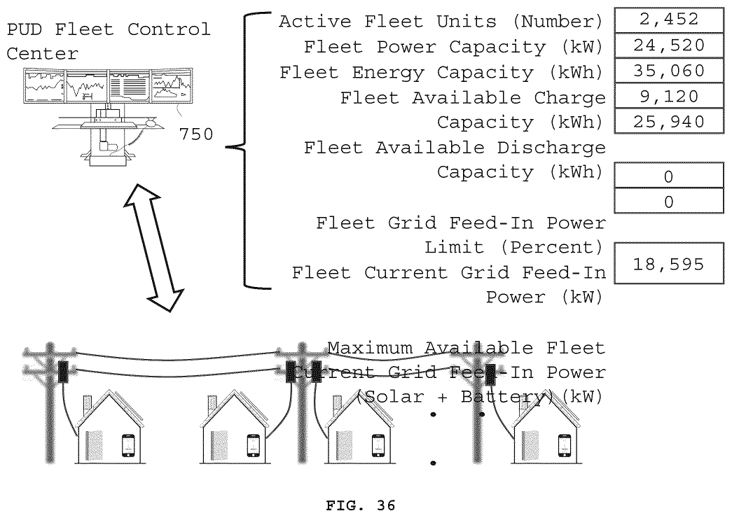

FIG. 36 illustrates a case where the PUD wants to stop all of the power being feed back to the grid by the fleet units. In this case, the PUD sends a power limit of 0% to the fleet units, and the power feed back to the grid by the fleet units changes from 8,595 kW to 0 kW. This reduces the power being feed back to the grid by the fleet units by 100%.

Those skilled in the relevant art(s) will readily appreciate that various adaptations and modifications of the exemplary embodiments described above can be achieved without departing from the scope and spirit of the present disclosure. Therefore, it is to be understood that, within the scope of the appended claims, the teachings of the disclosure may be practiced other than as specifically described herein.

What is claimed is:

1. A communications controller for a battery energy storage system (BESS) unit, the communication controller comprising:
a memory that stores a plurality of characteristics, parameters, or attributes of the BESS unit; and
a processor configured to execute instructions stored in the memory, the instructions, when executed by the processor, configuring the processor to:
start an error timer that expires at a discrete interval in time,
read the plurality of characteristics, parameters, or attributes from the memory,
analyze the plurality of characteristics, parameters, or attributes to detect errors, faults, failures, performance degradation, or maintenance needs for the BESS unit,
generate a negative status message for delivery to a remote monitoring station to indicate that the BESS unit is not operating normally in response to detecting the errors, faults, failures, the performance degradation, or the maintenance needs, and
generate a positive status message for delivery to the remote monitoring station to indicate that the BESS unit is operating normally in response to not detecting the errors, faults, failures, the performance degradation, or the maintenance needs before expiration of the discrete interval in time.

2. The communications controller of claim 1, wherein the instructions, when executed by the processor, further configure the processor to receive the plurality of characteristics, parameters, or attributes from a Battery Management System (BMS).

3. The communications controller of claim 1, wherein the plurality of characteristics, parameters, or attributes received from the BMS comprise State of Charge (SOC), State of Health (SOH), Voltage, Current, Temperature, Cycle Count, Capacity, Internal Resistance, Fault Detection, Charge/Discharge Rates, State of Power (SOP), Cell Balancing, or Ambient Conditions.

4. The communications controller of claim 1, wherein the instructions, when executed by the processor, further configure the processor to receive the plurality of characteristics, parameters, or attributes from a power converter.

5. The communications controller of claim 4, wherein the plurality of characteristics, parameters, or attributes received from the power converter comprise Voltage, Current, Power Flow, Efficiency, Temperature, Power Factor, Frequency, DC-Link Voltage, Harmonics, Overvoltage and Undervoltage Protection, Overcurrent Protection, Fault Detection and Diagnostics, Inverter Synchronization, or Load Demand.

6. The communications controller of claim 1, wherein the communications controller further comprises a plurality of data ports, and
wherein the instructions, when executed by the processor, further configure the processor to:
receive the plurality of characteristics, parameters, or attributes from corresponding wired data ports from among the plurality of data ports, and
provide the negative status message or the positive status message to corresponding wireless data ports from among the plurality of data ports for transmission to the remote monitoring station.

7. The communications controller of claim 1, wherein the negative status message comprises an error code or alarm relating to the errors, faults, failures, the performance degradation, or the maintenance needs.

8. A method for operating a battery energy storage system (BESS) unit, the method comprising:
starting, by a communications controller, an error timer that expires at a discrete interval in time;
reading, by the communications controller, a plurality of characteristics, parameters, or attributes of the BESS unit;
analyzing, by the communications controller, the plurality of characteristics, parameters, or attributes to detect errors, faults, failures, performance degradation, or maintenance needs for the BESS unit;
generating, by the communications controller, a negative status message for delivery to a remote monitoring station to indicate that the BESS unit is not operating normally in response to detecting the errors, faults, failures, the performance degradation, or the maintenance needs; and
generating, by the communications controller, a positive status message for delivery to the remote monitoring station to indicate that the BESS unit is operating normally in response to not detecting the errors, faults, failures, the performance degradation, or the maintenance needs before expiration of the discrete interval in time.

9. The method of claim 8, further comprising receiving, by the communications controller, the plurality of characteristics, parameters, or attributes from a Battery Management System (BMS).

10. The method of claim 8, wherein the plurality of characteristics, parameters, or attributes received from the BMS comprise State of Charge (SOC), State of Health (SOH), Voltage, Current, Temperature, Cycle Count, Capacity, Internal Resistance, Fault Detection, Charge/Discharge Rates, State of Power (SOP), Cell Balancing, or Ambient Conditions.

11. The method of claim 8, further comprising receiving, by the communications controller, the plurality of characteristics, parameters, or attributes from a power converter.

12. The communications controller of claim 4, wherein the plurality of characteristics, parameters, or attributes received from the power converter comprise Voltage, Current, Power Flow, Efficiency, Temperature, Power Factor, Frequency, DC-Link Voltage, Harmonics, Overvoltage and Undervoltage Protection, Overcurrent Protection, Fault Detection and Diagnostics, Inverter Synchronization, or Load Demand.

13. The method of claim 8, further comprising:
receiving, by the communications controller, the plurality of characteristics, parameters, or attributes from corresponding wired data ports from among a plurality of data ports; and
providing, by the communications controller, the negative status message or the positive status message to corresponding wireless data ports from among the plurality of data ports for transmission to the remote monitoring station.

14. The method of claim 8, wherein the negative status message comprises an error code or alarm relating to the errors, faults, failures, the performance degradation, or the maintenance needs.

15. A battery energy storage system (BESS) unit, the BESS unit comprising:
a Battery Management System (BMS) configured to monitor a first plurality of characteristics, parameters, or attributes of the BESS unit;
a power converter configured to monitor a second plurality of characteristics, parameters, or attributes of the BESS unit;
a communications controller configured to:
store the first plurality of characteristics, parameters, or attributes and the second plurality of characteristics, parameters, or attributes;
start an error timer that expires at a discrete interval in time,
analyze the first plurality of characteristics, parameters, or attributes and the second plurality of characteristics, parameters, or attributes to detect errors, faults, failures, performance degradation, or maintenance needs for the BESS unit,
generate a negative status message for delivery to a remote monitoring station to indicate that the BESS unit is not operating normally in response to detecting the errors, faults, failures, the performance degradation, or the maintenance needs, and
generate a positive status message for delivery to the remote monitoring station to indicate that the BESS unit is operating normally in response to not detecting the errors, faults, failures, the performance degradation, or the maintenance needs before expiration of the discrete interval in time.

16. The BESS unit of claim 15, wherein the first plurality of characteristics, parameters, or attributes received from the BMS comprise State of Charge (SOC), State of Health (SOH), Voltage, Current, Temperature, Cycle Count, Capacity, Internal Resistance, Fault Detection, Charge/Discharge Rates, State of Power (SOP), Cell Balancing, or Ambient Conditions.

17. The BESS unit of claim 15, wherein the second plurality of characteristics, parameters, or attributes received from the power converter comprise Voltage, Current, Power Flow, Efficiency, Temperature, Power Factor, Frequency, DC-Link Voltage, Harmonics, Overvoltage and Undervoltage Protection, Overcurrent Protection, Fault Detection and Diagnostics, Inverter Synchronization, or Load Demand.

18. The BESS unit of claim 15, further comprising:
a plurality of data ports,
wherein the communications controller is further configured to:
receive the first plurality of characteristics, parameters, or attributes from corresponding first wired data ports coupled to the BMS from among the plurality of data ports, and
receive the second plurality of characteristics, parameters, or attributes from corresponding second wired data ports coupled to the power converter from among the plurality of data ports.

19. The BESS unit of claim 18, wherein the communications controller is further configured to provide the negative status message or the positive status message to corresponding wireless data ports from among the plurality of data ports for transmission to the remote monitoring station.

20. The BESS unit of claim 15, wherein the negative status message comprises an error code or alarm relating to the errors, faults, failures, the performance degradation, or the maintenance needs.
